(19) United States
(12) Patent Application Publication
(10) Pub. No.: US 2016/0171541 A1
(43) Pub. Date: Jun. 16, 2016

(54) System and Method for Managing Prospects

(71) Applicant: THE REYNOLDS AND REYNOLDS COMPANY, Kettering, OH (US)

(72) Inventor: Robert T. BROCKMAN, Houston, TX (US)

(21) Appl. No.: 14/968,443

(22) Filed: Dec. 14, 2015

Related U.S. Application Data
(60) Provisional application No. 62/092,067, filed on Dec. 15, 2014.

(51) Int. Cl. G06Q 30/02

(52) U.S. Cl. CPC G06Q 30/0255; G06Q 30/0257; G06Q 30/0276

(57) ABSTRACT

A method for managing prospects includes generating a follow-up activity for a prospect, the prospect associated with a client and a vehicle. The follow-up activity is generated based on a results-based schedule. The follow-up activity is assigned to a user. After carrying out the follow-up activity, the user inputs the result of the follow-up activity. A new follow-up activity is generated based at least in part on the result.

### CROSS-REFERENCE TO RELATED APPLICATIONS

The present application claims priority from U.S. Provisional Patent Application No. 62/092,067, filed on Dec. 15, 2014, the entirety of which is incorporated herein by reference.

### TECHNICAL FIELD/FIELD OF THE DISCLOSURE

The present disclosure relates generally to computerized methods for managing prospects and potential prospects for sales of vehicles.

### BACKGROUND OF THE DISCLOSURE

Dealerships may desire a process for developing and managing potential clients and vehicle sales. Management of these potential clients and vehicle sales may be complicated by the multiple points at which persons in the dealership that interact with the client and the many potential methods by which the client interacts with those dealership employees. Further, follow-up with potential clients may facilitate purchases by those clients that might otherwise not occur had follow-up not occurred.

### SUMMARY

The present disclosure provides for a method. The method may include generating a prospect using a computer. The prospect may be associated with a vehicle. The method may further include generating a follow-up activity for the prospect. The follow-up activity may be determined by a results-based schedule. The method may further include assigning the follow-up activity to a user; generating at least one result based on the follow-up activity; carrying out the follow-up activity by the user; inputting at least one result into the computer; and repeating steps (b)-(e) based at least in part on the result.

The present disclosure further provides for a method. The method may include selecting a campaign type, selecting criteria for prospects of the campaign, and creating content for the campaign.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a flow chart of prospect management system consistent with at least one embodiment of the present disclosure.

FIG. 2 is a screen shot of a prospect management system consistent with at least one embodiment of the present disclosure.

FIG. 3 is a screen shot of a prospect management system consistent with at least one embodiment of the present disclosure.

FIG. 4 is a screen shot of a prospect management system consistent with at least one embodiment of the present disclosure.

FIG. 5 is a screen shot of a prospect management system consistent with at least one embodiment of the present disclosure.

FIG. 6 is a screen shot of a prospect management system consistent with at least one embodiment of the present disclosure.

FIG. 7 is a screen shot of a prospect management system consistent with at least one embodiment of the present disclosure.

FIG. 8 is a flow chart of a results-based schedule consistent with at least one embodiment of the present disclosure.

FIG. 9 is a flow chart of a time-based schedule.

FIG. 10 is a screen shot of a prospect management system consistent with at least one embodiment of the present disclosure.

FIG. 11 is a screen shot of a prospect management system consistent with at least one embodiment of the present disclosure.

FIG. 12 is a screen shot of a prospect management system consistent with at least one embodiment of the present disclosure.

FIG. 13 is a screen shot of a prospect management system consistent with at least one embodiment of the present disclosure.

FIG. 13 is a screen shot of a prospect management system consistent with at least one embodiment of the present disclosure.

FIG. 14 is a flow chart of a campaign selection system consistent with at least one embodiment of the present disclosure.

FIG. 15 is a screen shot of a campaign selection system consistent with at least one embodiment of the present disclosure.

FIG. 16 is a screen shot of a campaign selection system consistent with at least one embodiment of the present disclosure.

FIG. 17 is a screen shot of a campaign selection system consistent with at least one embodiment of the present disclosure.

FIG. 18 is a screen shot of a campaign selection system consistent with at least one embodiment of the present disclosure.

FIG. 19 is a screen shot of a campaign selection system consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

As used herein, “client” refers to the person or entity who may be interested in purchasing a vehicle.

As used herein, “prospect” refers to an opportunity for a vehicle sale. A client may have more than one prospect.

As used herein, a “GUI” is a graphical user interface. A GUI may allow data to be displayed and entered. In certain non-limiting embodiments, the GUIs described below may be customized depending on the device on which they are displayed. For instance, my desk prospects GUI 200 as discussed below may display different information when displayed on a computer terminal screen then when displayed on a tablet or smartphone screen.

As described herein, a “user” is any person operating a prospect management system, such as through, for instance, a GUI.

As used herein, “generate” refers to an action taken by a computer.

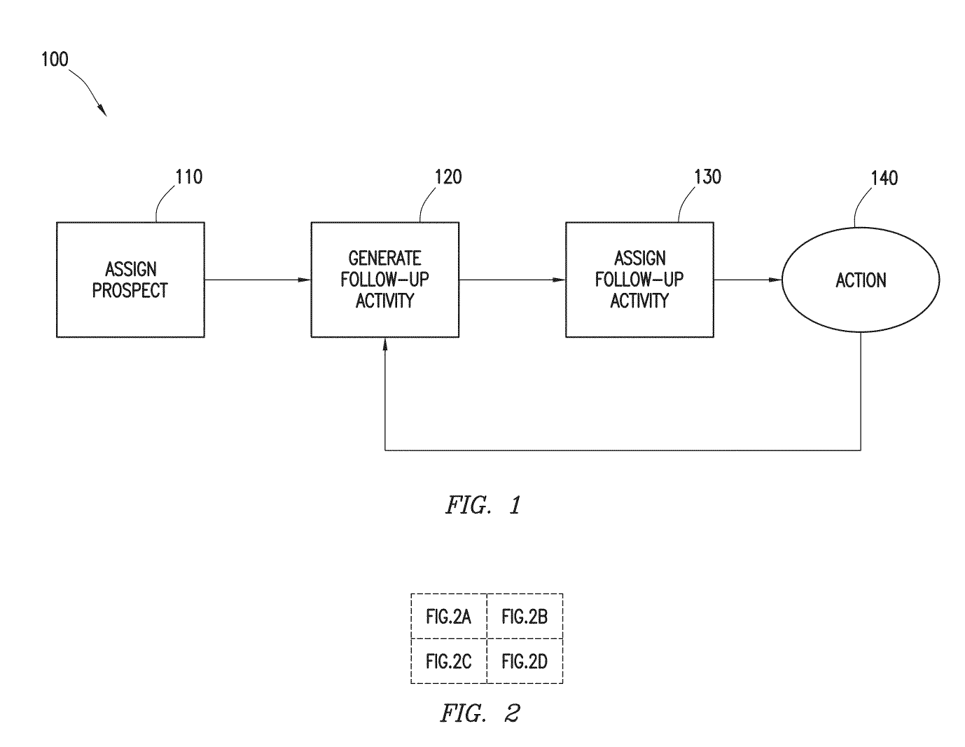

As depicted in FIG. 1, in some embodiments of the present disclosure, prospect management system 100, may include the steps of assign prospect 110, generate follow up activity 120, assign follow-up activity 130 and action 140.

In assign prospect 110, a prospect of the dealership is assigned to an employee of the dealership, such as a salesperson. A prospect may be assigned in assign prospect 110 by an employee of the dealership, such as a dealership sales manager, or by rules engine that may consider such assignment factors as when the salesperson became available for receiving prospects, the ranking of the salesperson (such as a ranking of the salesperson's skills or effectiveness by a dealership manager), ineligibility for assignment of a prospect due to incomplete tasks and assignment rotation. “Assignment rotation” means that the rules engine may consider which salesperson was last assigned a prospect and may then consider the next salesperson on a predefined list of salespersons. Assignment rotation may skip listed salespersons, for instance, if the salesperson is absent or otherwise not available. In some embodiments, assignment rotation may also consider the other assignment factors. “Assigned” means that the employee such as the salesperson is responsible for interaction with the client associated with the prospect for such tasks as, for instance and without limitation, selecting a vehicle, demonstrating the vehicle, adding information about the client or the prospect into the dealership's prospect database, answering questions about the prospect, negotiating with the client regarding the price and sales terms of purchasing the vehicle, and assisting the client with taking delivery of the vehicle. In certain embodiments of the present disclosure, assign prospect 110 may include receiving signals from input devices and databases representing such physical aspects as information about the client, and information about the prospect into a computer system. Assign prospect 110 may use one or more GUIs to collect and display prospects, as described further below.

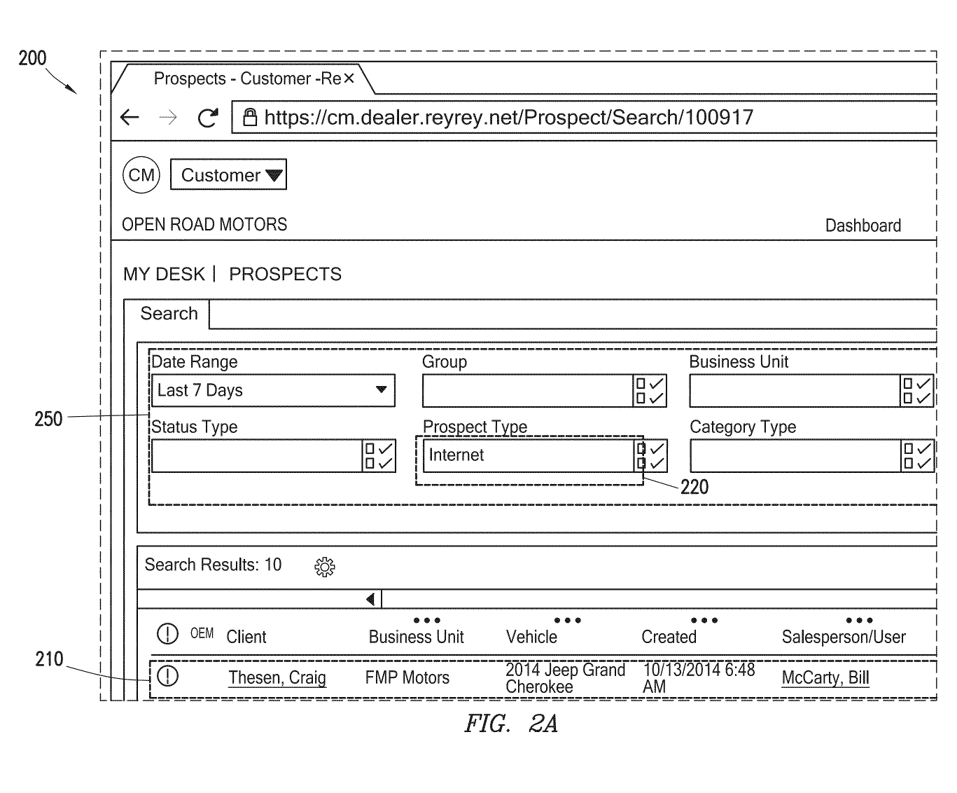

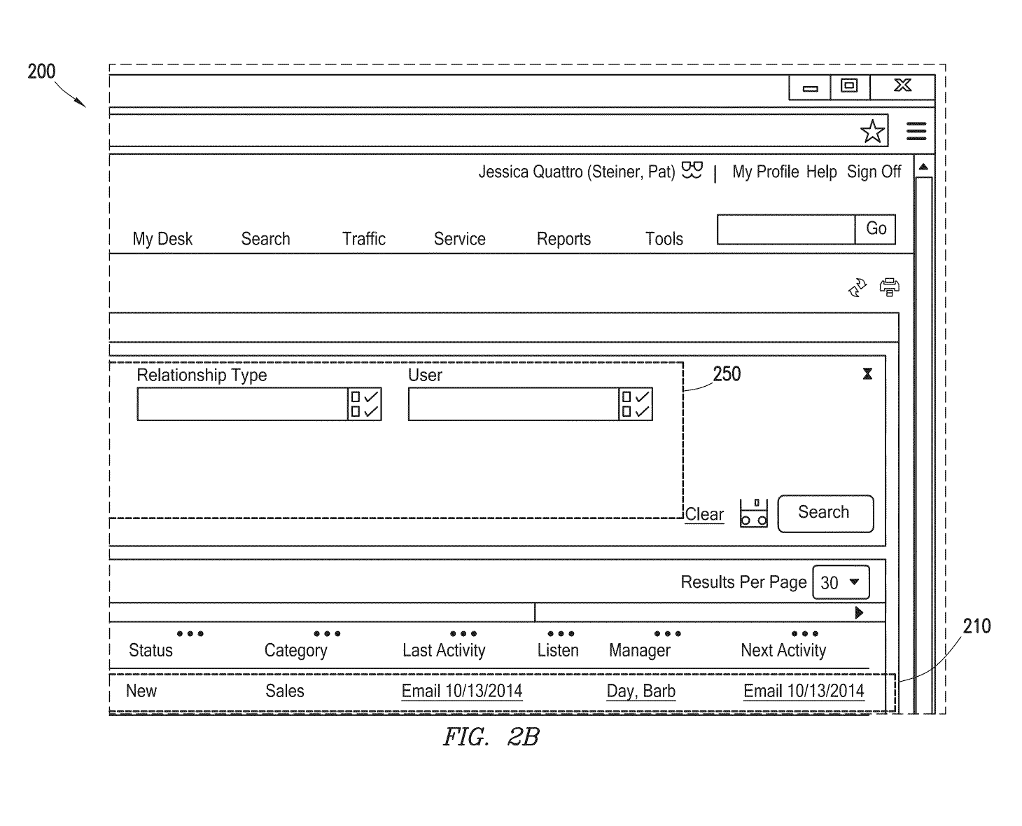

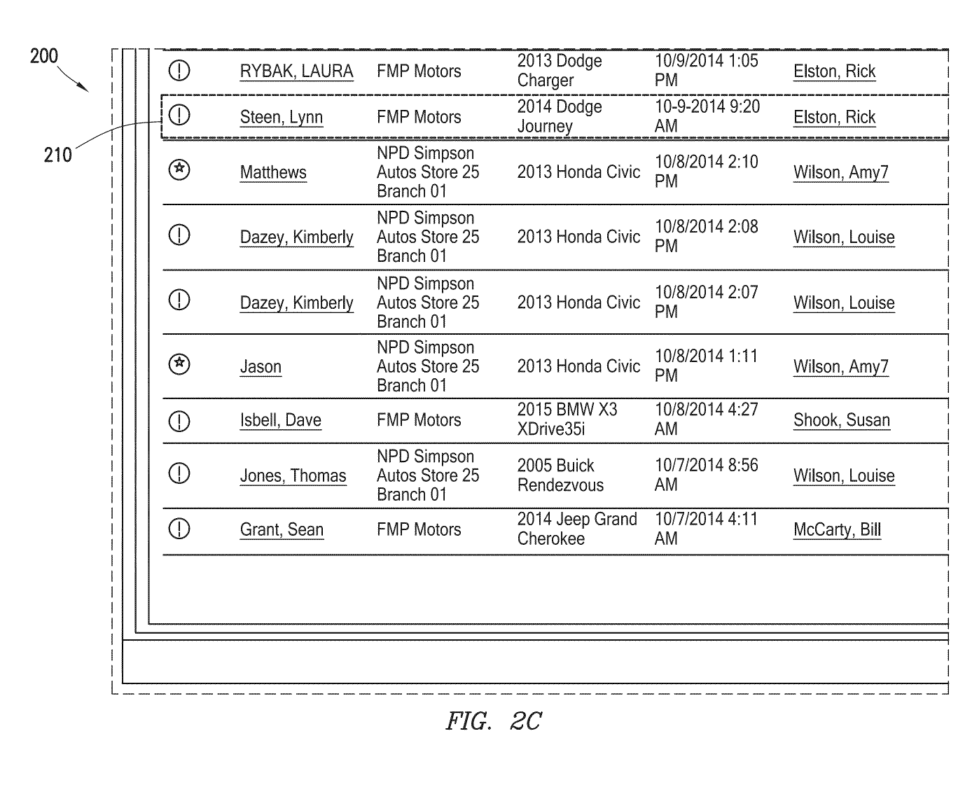

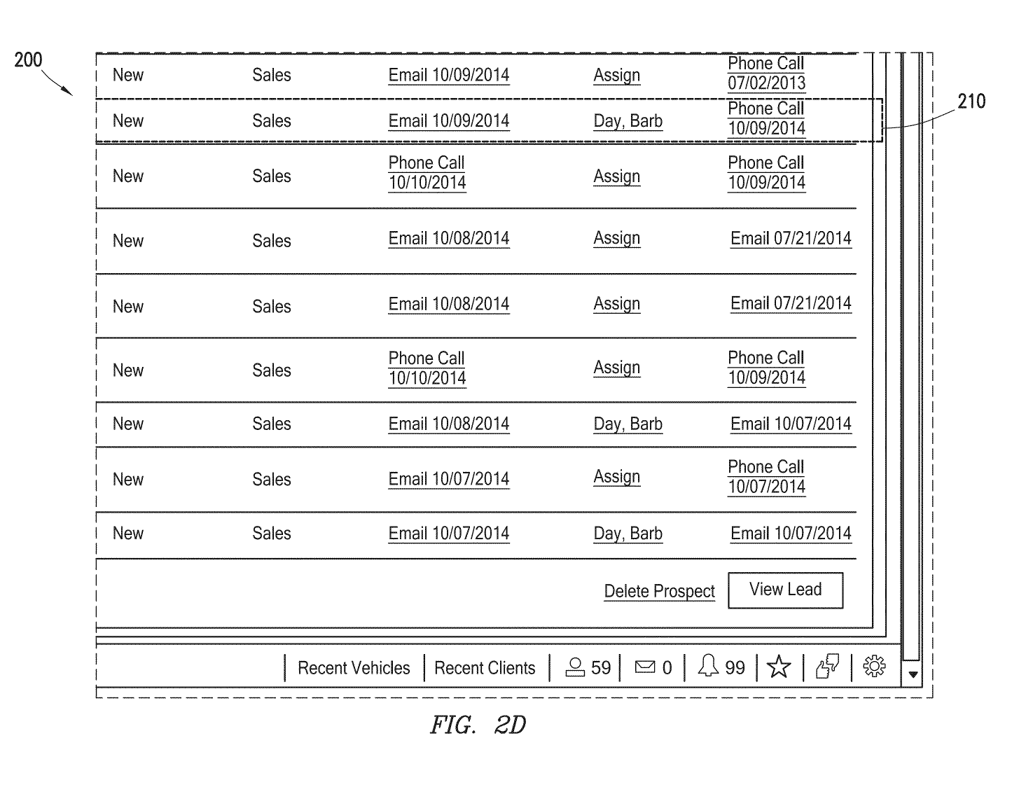

In some embodiments of the present disclosure, as part of assign prospect 110, as depicted in FIG. 2, a plurality of prospects, two of which are shown as a plurality of prospects 210, may be displayed in my desk prospects GUI 200. In the embodiment shown in FIG. 2, prospect 210 may be associated with information such as, for example and without limitation, the client, business unit, the prospect vehicle, the date the prospect was created, the salesperson or user responsible for the prospect, the status of the prospect, last activity with respect to the prospect and the next activity scheduled for the prospect. Any information associated with prospect 210 may be displayed by my desk prospects GUI 200. In some embodiments, the source of the prospect may also be identified. For example and without limitation, the source of the prospect may include interne, radio, television, social media such as Facebook, and billboards. In certain embodiments, prospect type may be specified as Prospect Type 220. Prospect Type 220 may include walk-in, fax, list, phone, internet or other options, i.e., how the dealership was notified of the prospect. My desk prospects GUI 200 may be configurable to, for instance in certain embodiments, display to an individual user such as a salesperson all of the prospects currently assigned to that salesperson. Prospect information may be stored in non-transitory, tangible computer readable storage medium.

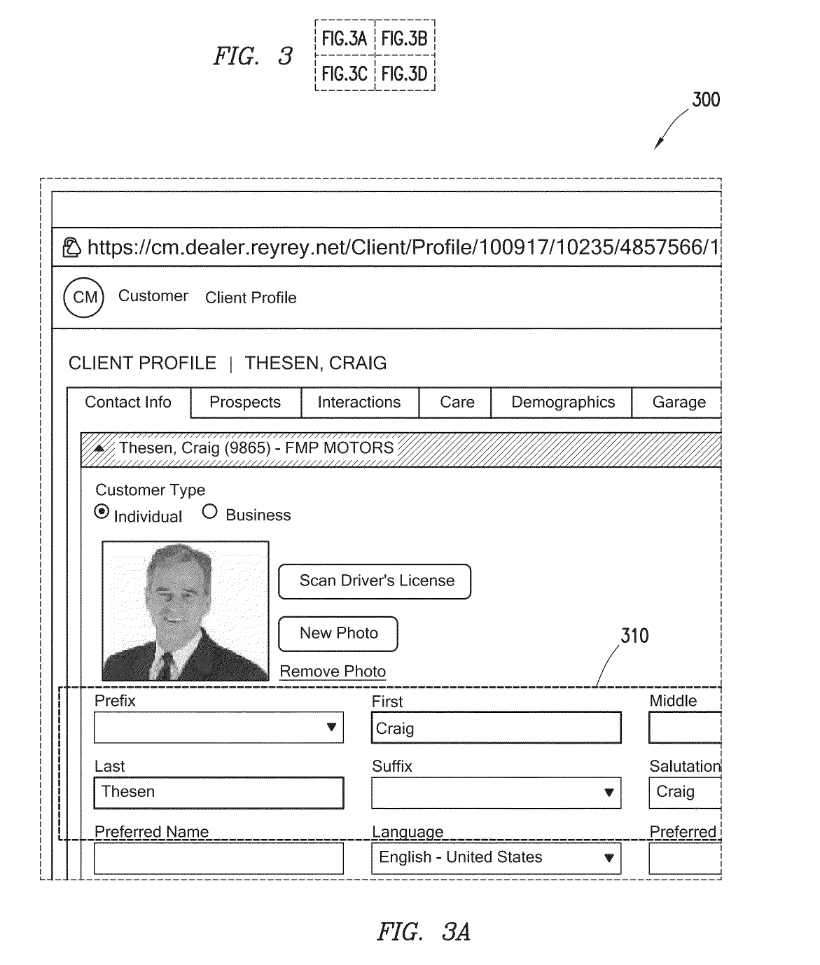

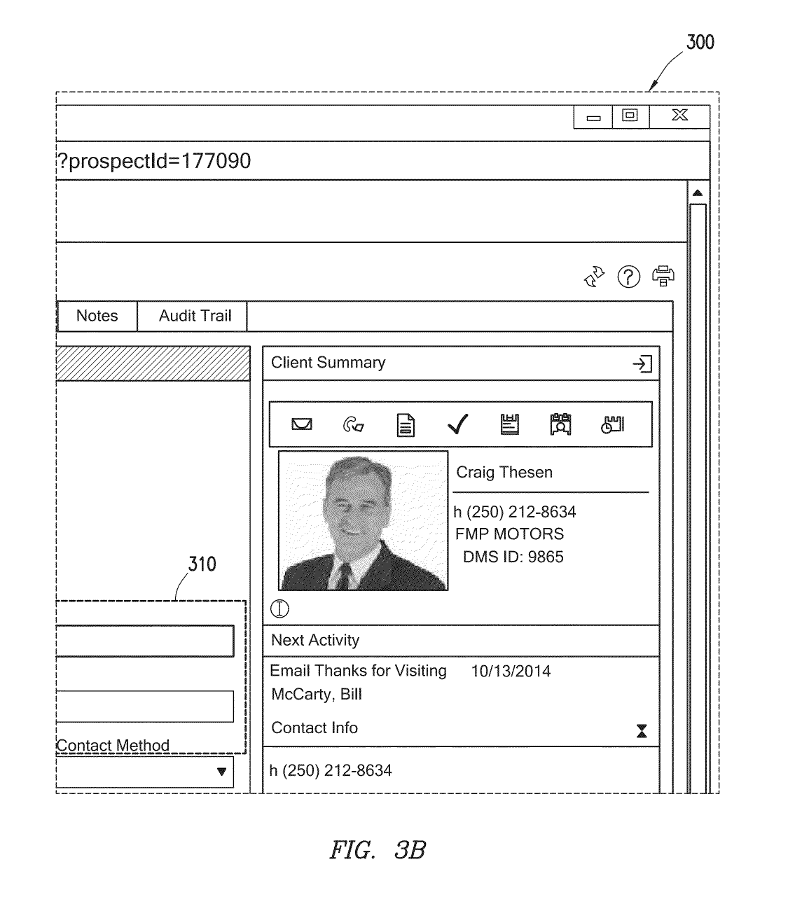

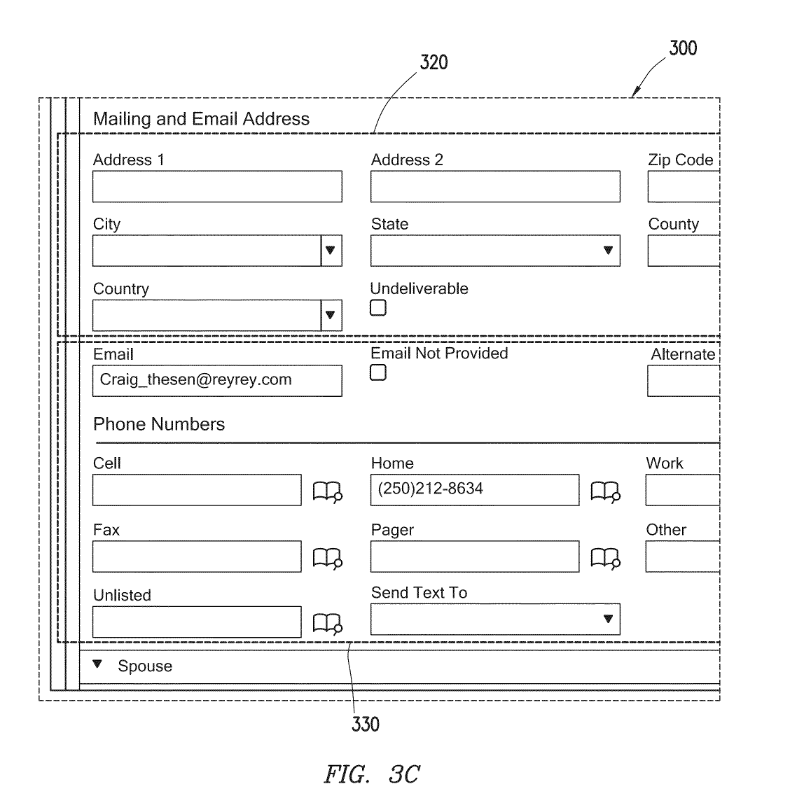

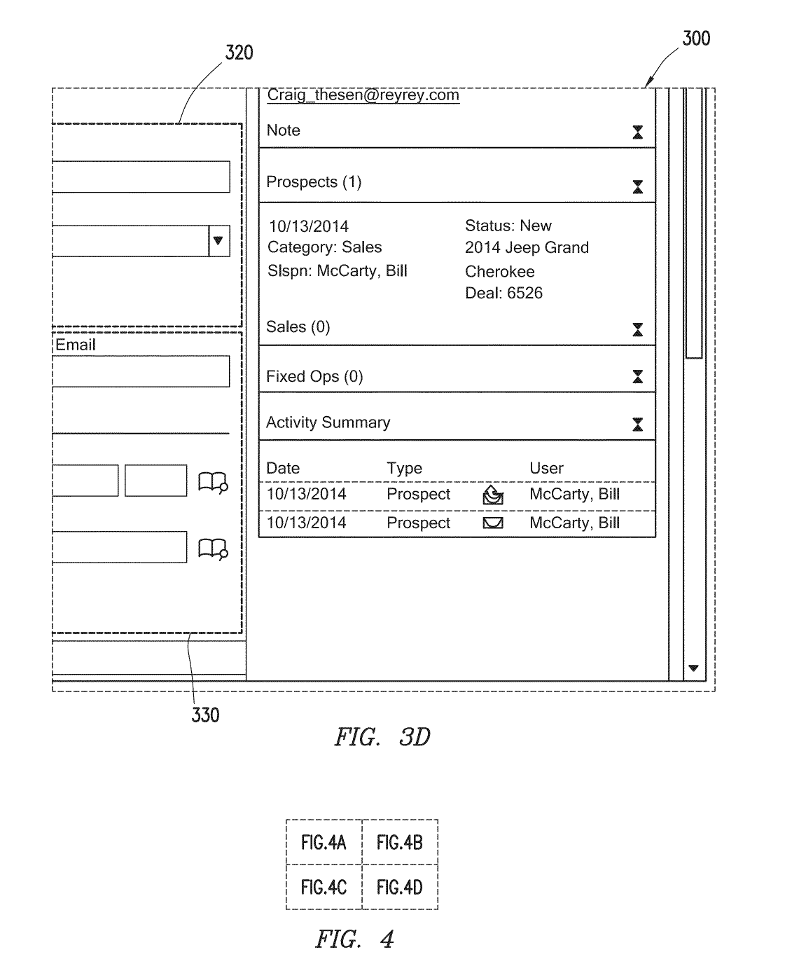

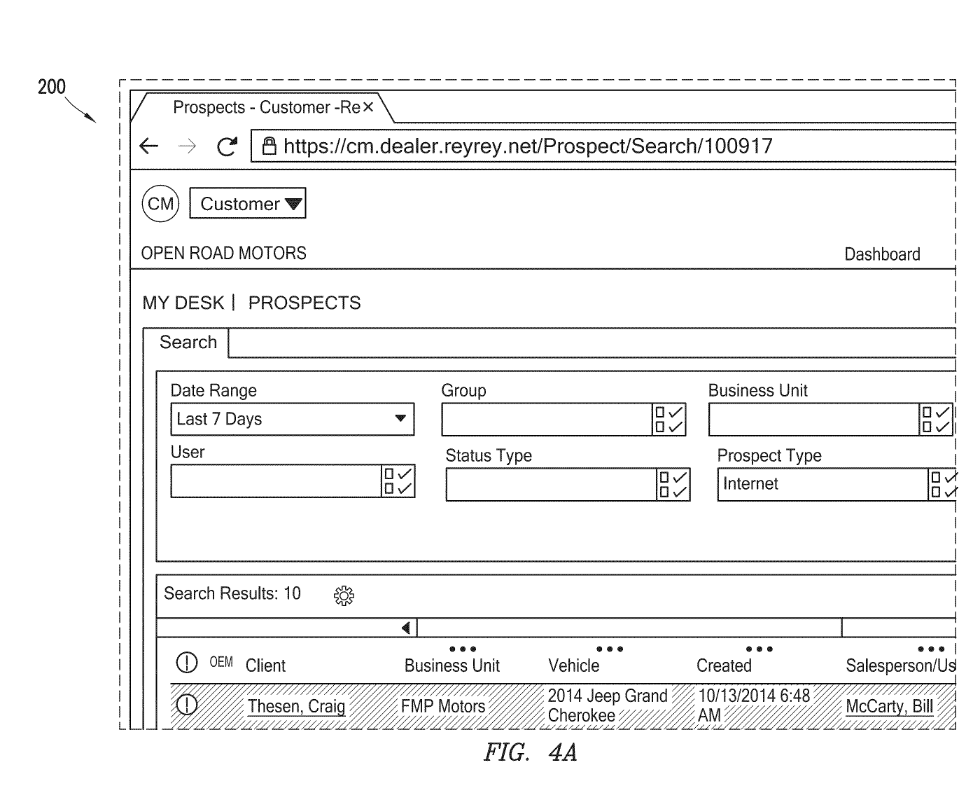

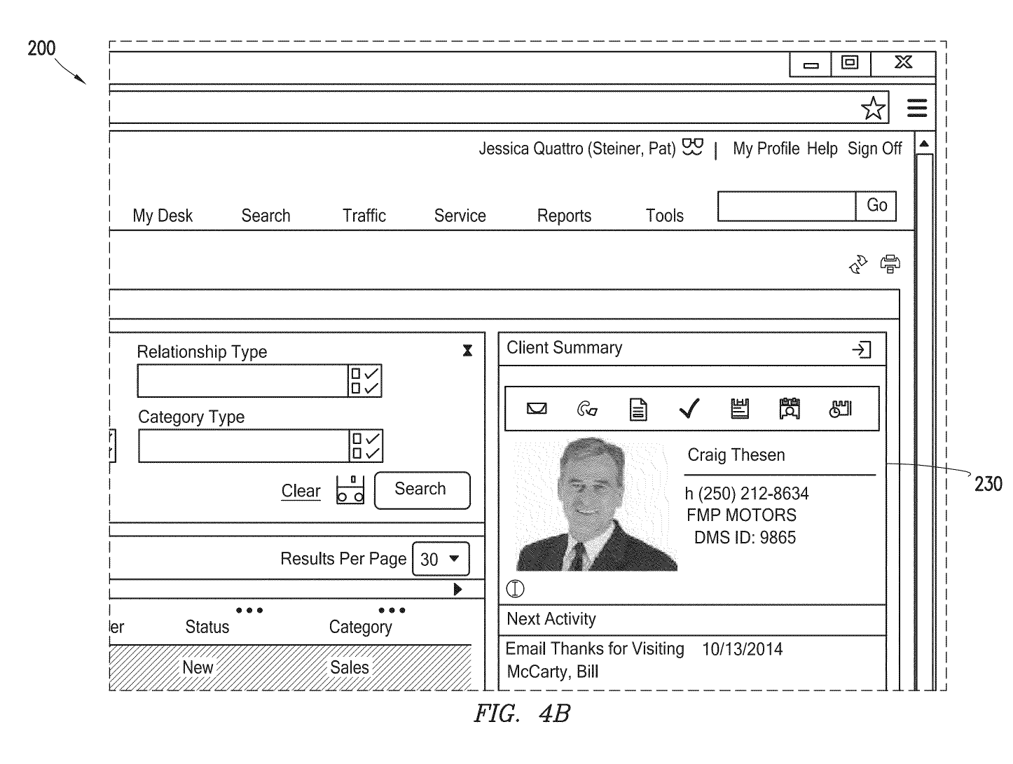

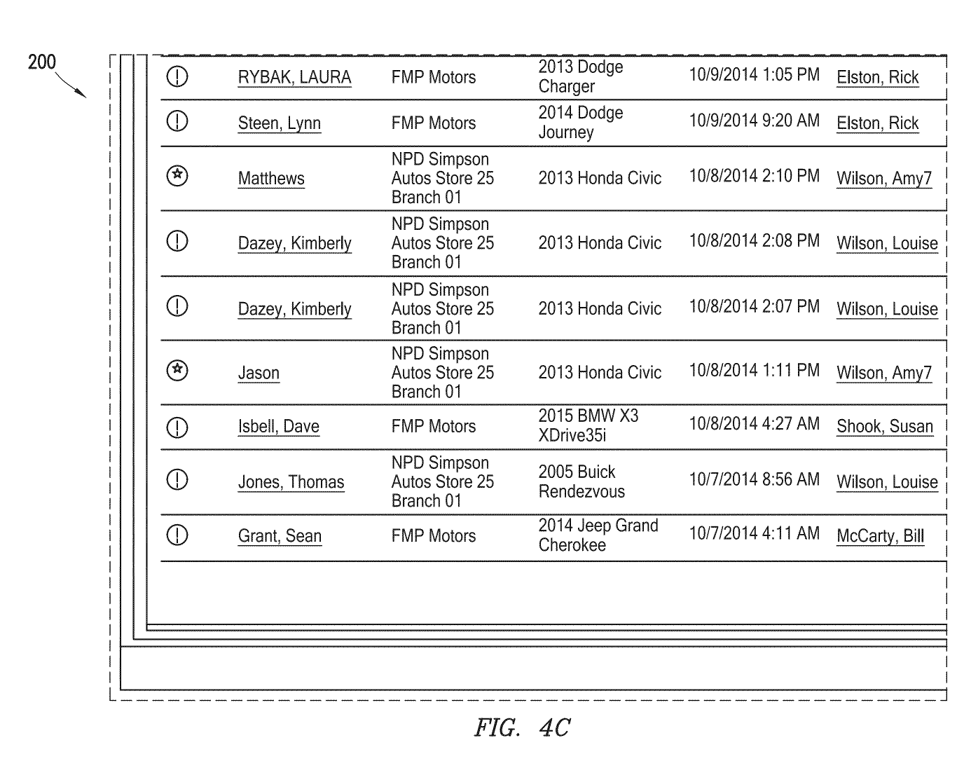

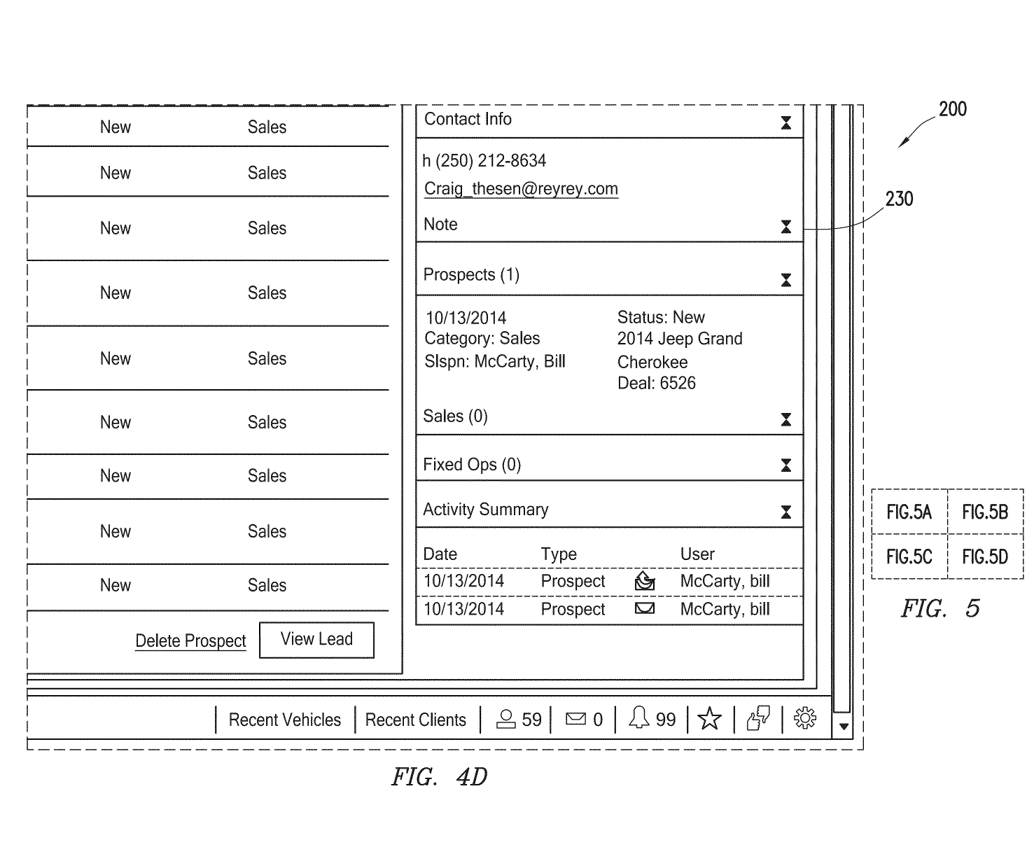

In some embodiments, the information reflected in my desk prospects GUI 200 may be transmitted into a computer system by a variety of methods. For instance, in some embodiments, as shown in FIG. 3, information regarding the client may be entered through Client Profile GUI 300. As shown in Client Profile GUI 300, information, including, for example and without limitation, the client's name 310, client's address 320 and client contact information 330 may be entered by a user, such as a salesperson, or, for customers and potential customers who have had previous interactions with the dealership, may be drawn from existing databases. In some embodiments, a summary of information regarding the client (“client profile”) entered through Client Profile GUI 300 may be available in my desk prospects GUI 200 as depicted in FIG. 4. The client profile includes, for instance, the client's name, address, and contact information. In some embodiments, a user may interact with my desk prospects GUI 200 in order to display the client profile. For example and without limitation, utilizing an interaction device such as a mouse, the user may interact with a button or other interactive feature. In some embodiments, by indicating a “client”, my desk prospects GUI 200 may be modified to display inset 230. Inset 230 may, in some embodiments, include some or all of the information available in the client profile. In certain embodiments, the step of assign prospect 110 may further include checking the information about the client to determine if the client is a duplicate client entry, i.e., a client profile that duplicates part or all of an existing client profile, and may take appropriate action, such as modifying or deleting the second or existing client profile. Determining if the client is a duplicate client entry may be accomplished by the employee to which the prospect is assigned or by a computer, wherein the computer compares client information to determine if client information the client duplicates an existing client profile. Client information may be stored in non-transitory, tangible computer readable storage medium

As further depicted in FIG. 2, in some embodiments, my desk prospects GUI 200 may provide a user the ability filter assigned prospects on a number of filterable criteria 250 and display only those prospects that fit the filterable criteria 250, i.e., the prospects are selectively displayable by the user. Filterable criteria 250 may include, for example and without limitation, date, group, business unit, relationship type, status type, category type and user. One of skill in the art with the benefit of this disclosure would recognize other filterable criteria 250. In certain embodiments, particular users may be prevented by my desk prospects GUI 200 from filtering using certain filterable criteria 250. For instance, as shown in FIG. 2, particular users may be prevented from displaying other user prospects by filtering using the user filterable criteria 250.

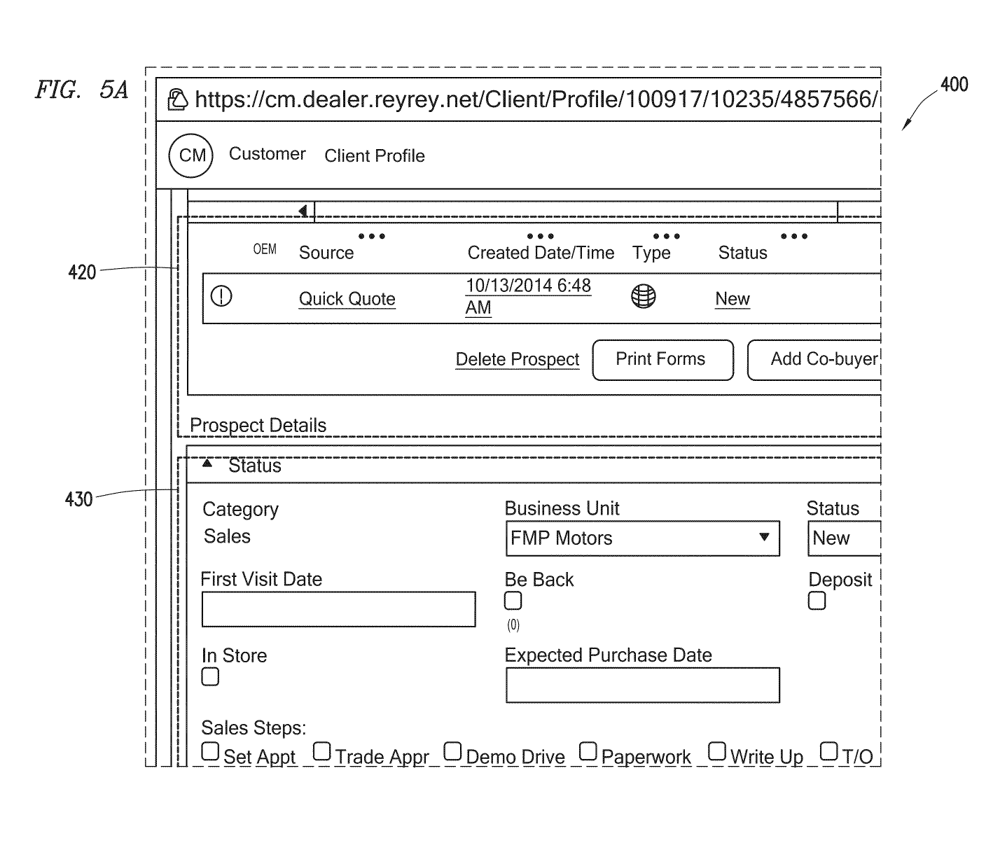

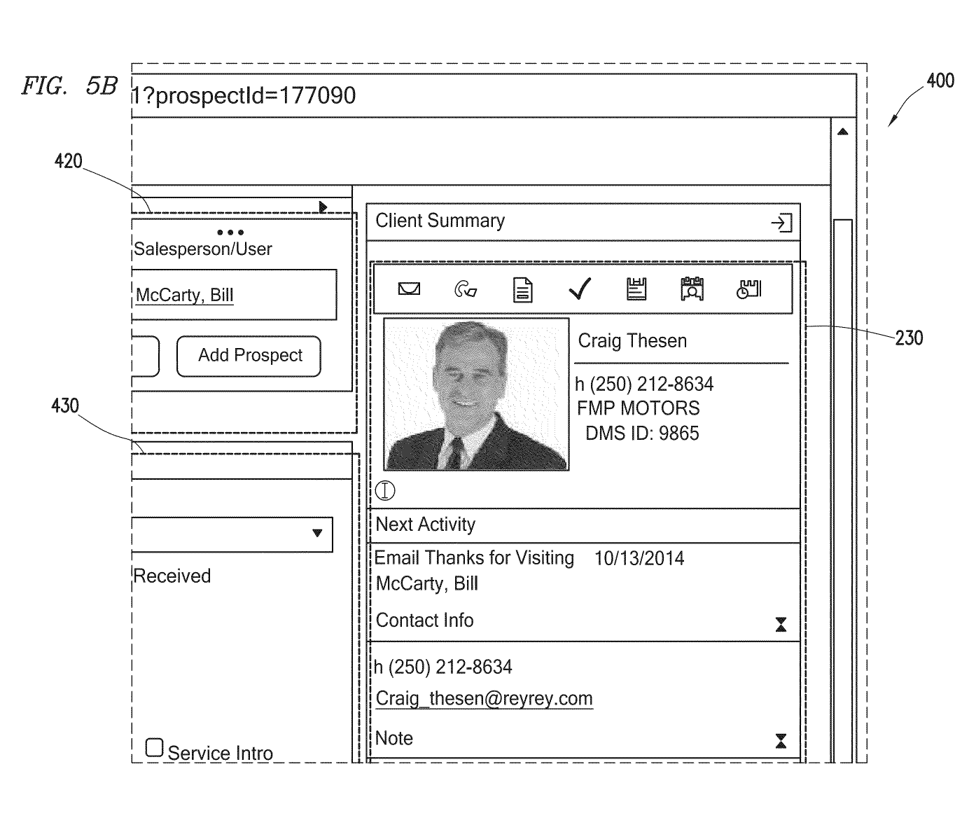

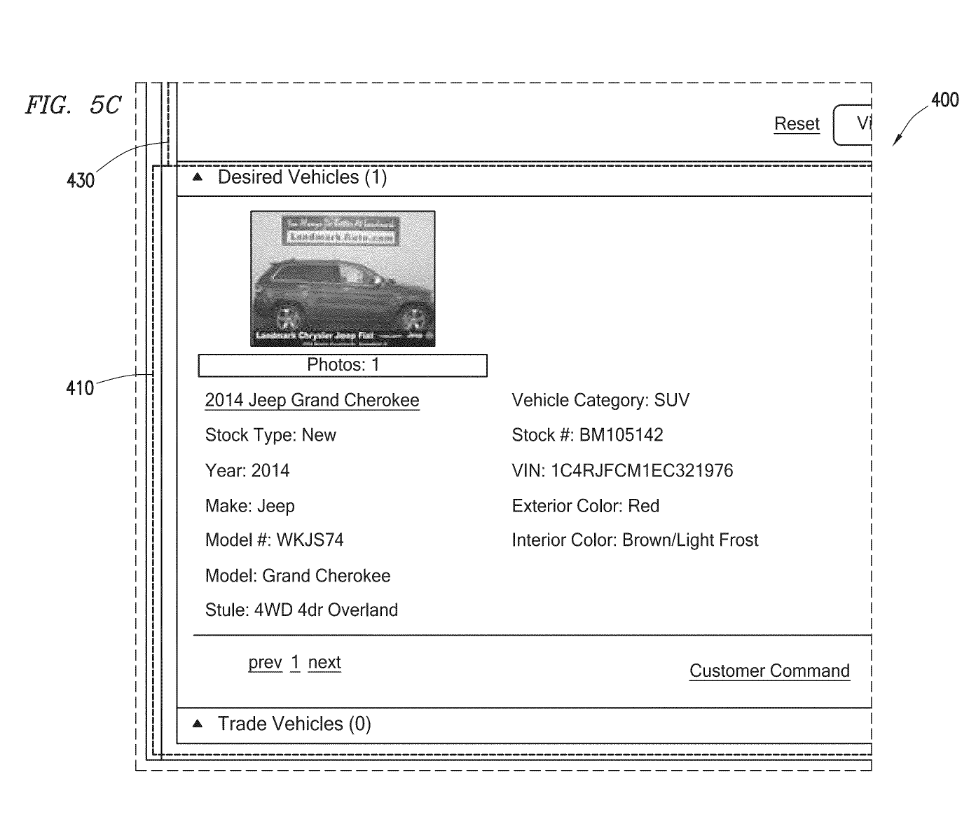

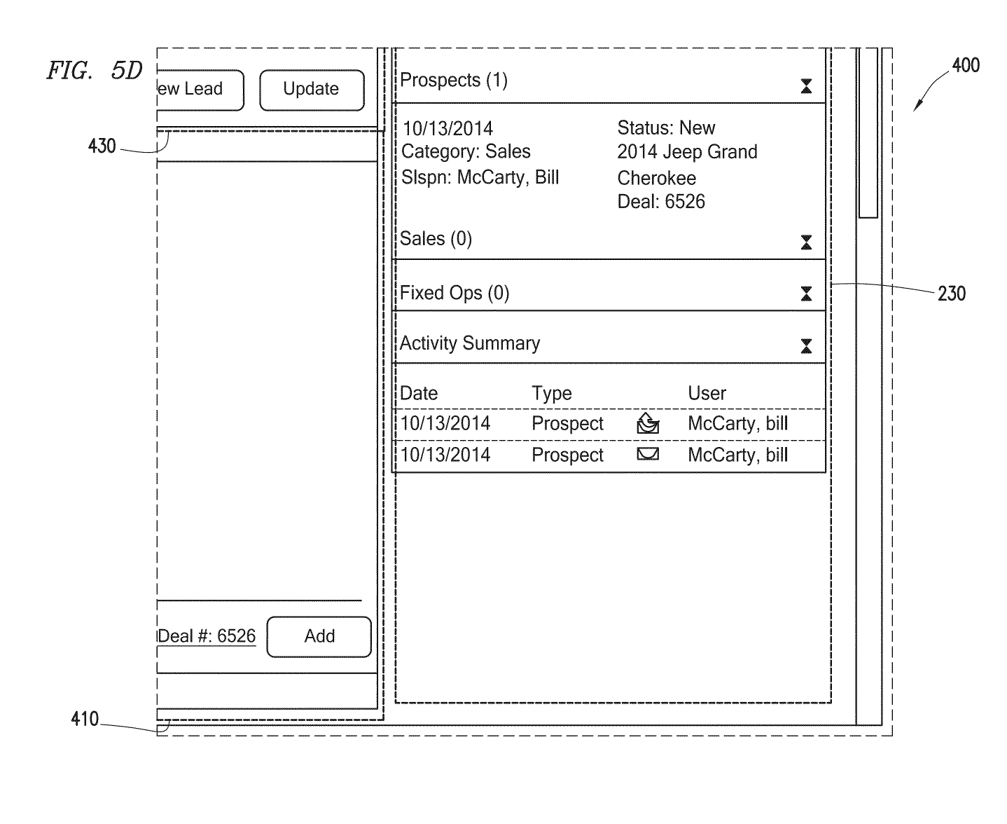

In certain embodiments of the present disclosure, a prospect may be displayed to the user during assign prospect 110. In some embodiments, as depicted in FIG. 5 the prospect and associated information may be displayed by prospect GUI 400. Prospect GUI 400 may be configured to display, for example and without limitation, profile insert 230 as previously discussed, desired vehicle 410, prospect identifiers 420, and prospect status indicators 430. Prospect status indicators 430 may, in some embodiments, indicate whether certain expected sales activities have or have not been conducted for the prospect. Prospect status indicators 430 may include, for example and without limitation, set appointment, trade appraisal, demo drive, paperwork, write up, T/O and service intro. In the embodiment shown in FIG. 5, status indicators 430 may be interactively designated by the user, such as a salesperson. Desired vehicle information displayed in prospect GUI 400 may include, for example and without limitation, the make and model of the vehicle, vehicle type (new or used), year, style, category, stock number, VIN number, and interior and exterior color. One having ordinary skill in the art with the benefit of this disclosure will understand that other vehicle information may also be displayed.

In some embodiments, information may be communicated by the client to a dealership employee, such as a salesperson, regarding or indicating the desired vehicle. In certain embodiments, assign prospect 110 may include querying a database, such as an external database, to determine if the desired vehicle is within the dealership inventory. In addition, in certain embodiments, for example, when the dealership may have multiple locations or relationships with other dealerships, the external database or other databases may be queried to determine if the desired vehicle is located at another location or dealership. Criteria used for such a match may include, for example and without limitation, vehicle type (new or used), model year, make, model, style, exterior color, interior color, price, and/or maximum mileage.

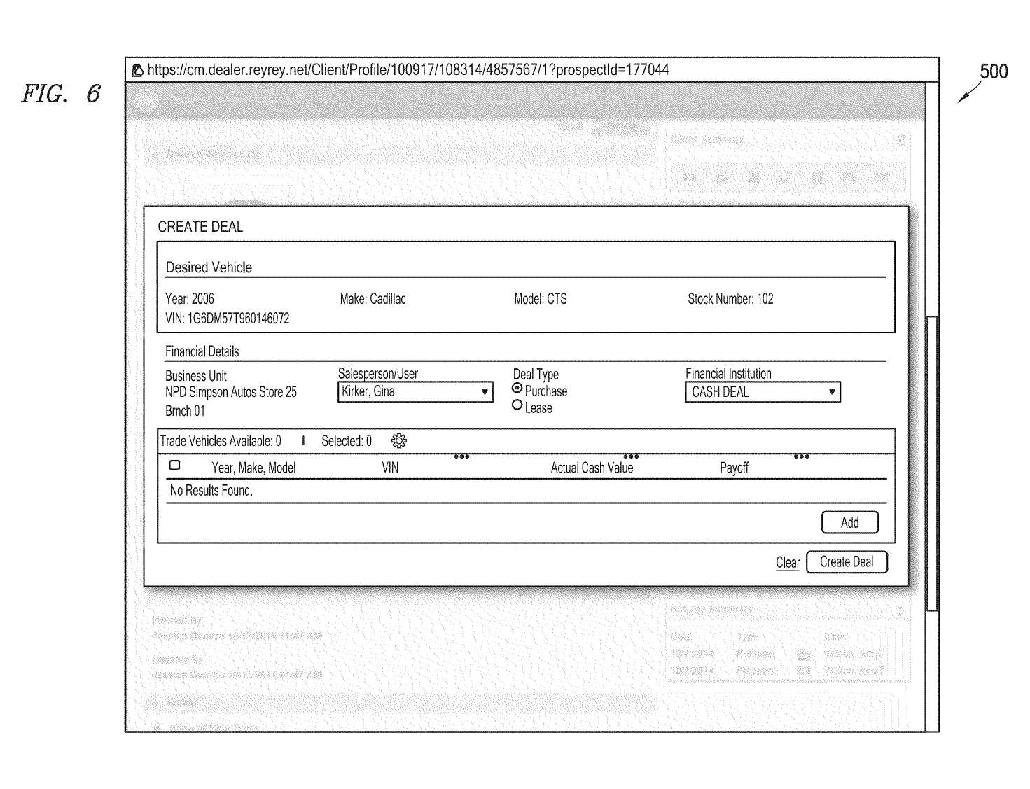

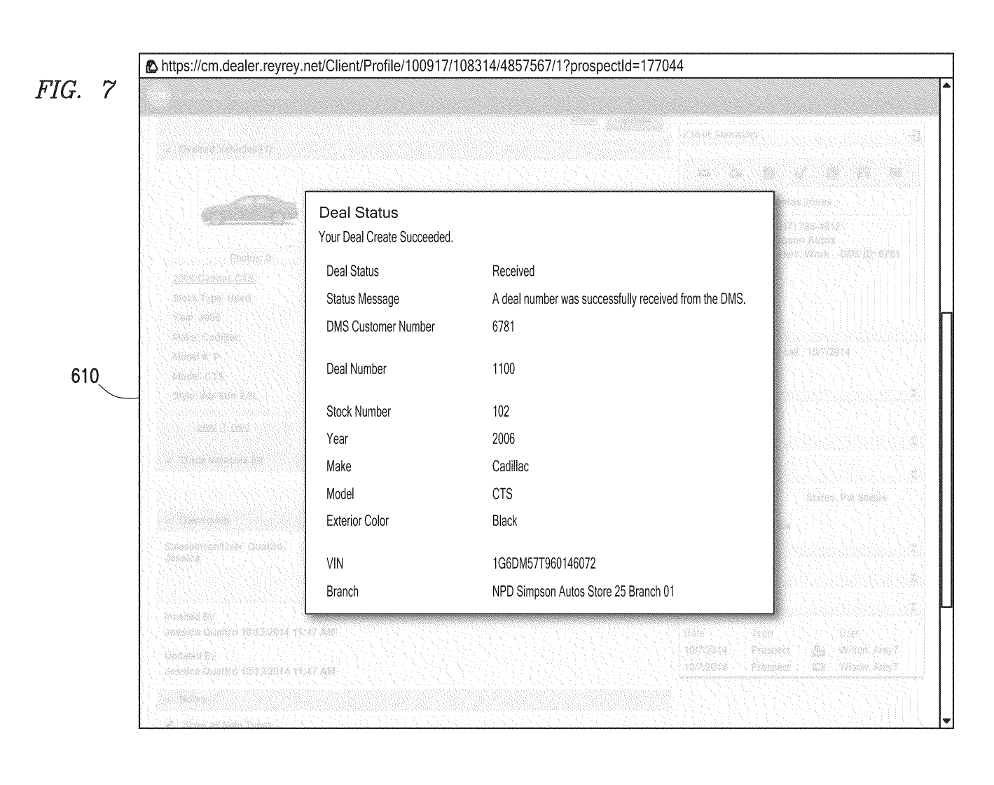

In certain embodiments of the present disclosure, a deal request as described in U.S. patent application Ser. No. 14/877,366, filed Oct. 7, 2015, which is incorporated herein fully by reference, may be created as part of assign prospect 110 or action 140. FIG. 6 depicts create deal GUI 500 in which a deal request may be created for entry into the prospect management system as described in U.S. Ser. No. 14/877,366. FIG. 7 depicts notification 610 indicating to the user that the deal request has been created and the vehicle information related to the deal request.

In certain embodiments of the present disclosure, assign prospect 110 may further include generating a prospect scorecard. The prospect scorecard may, for example and without limitation, identify a propensity to purchase score for prospects based on information provided by the client as well as other information regarding the client from internal or external databases.

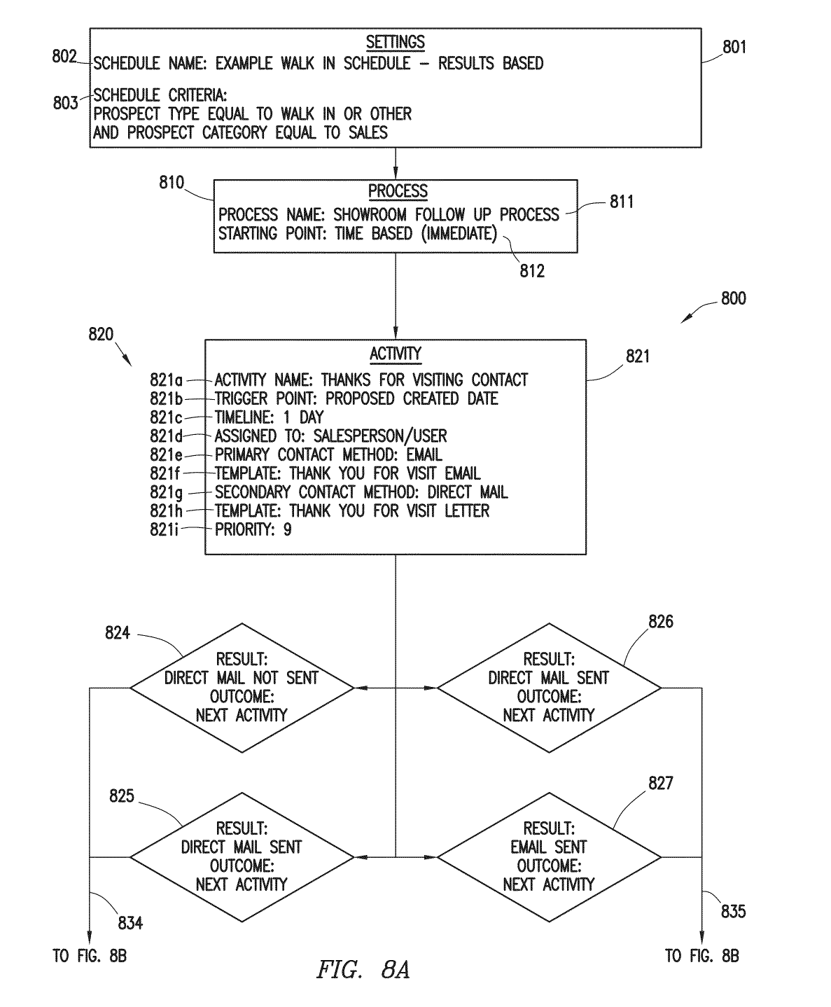

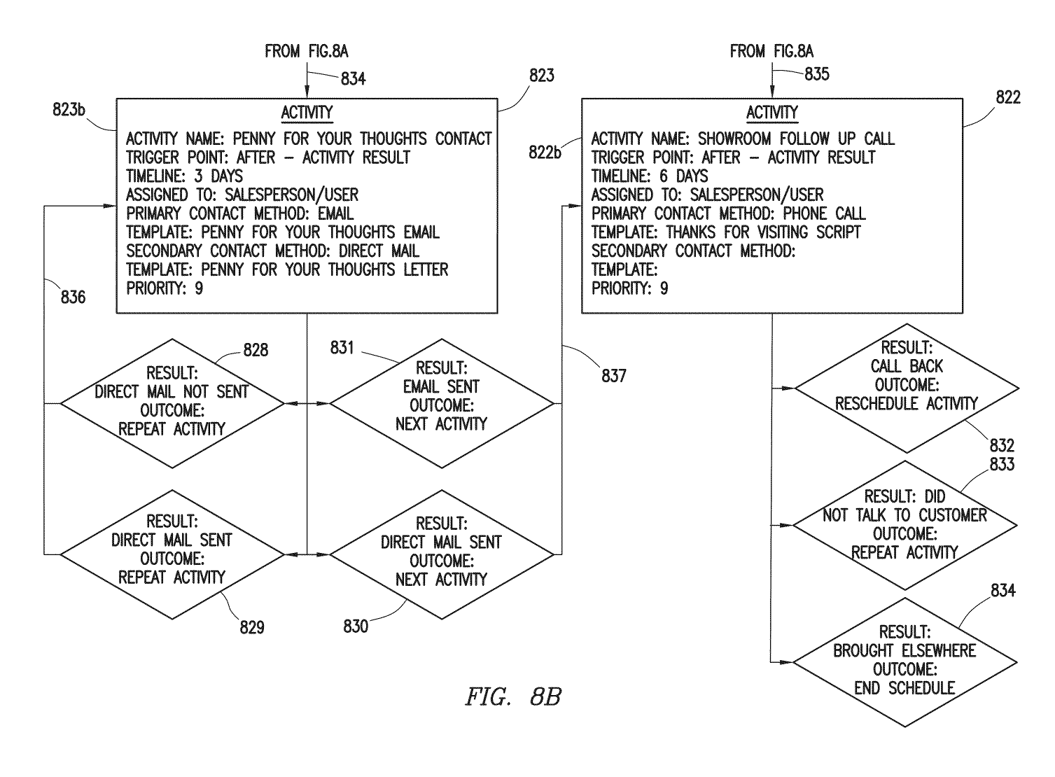

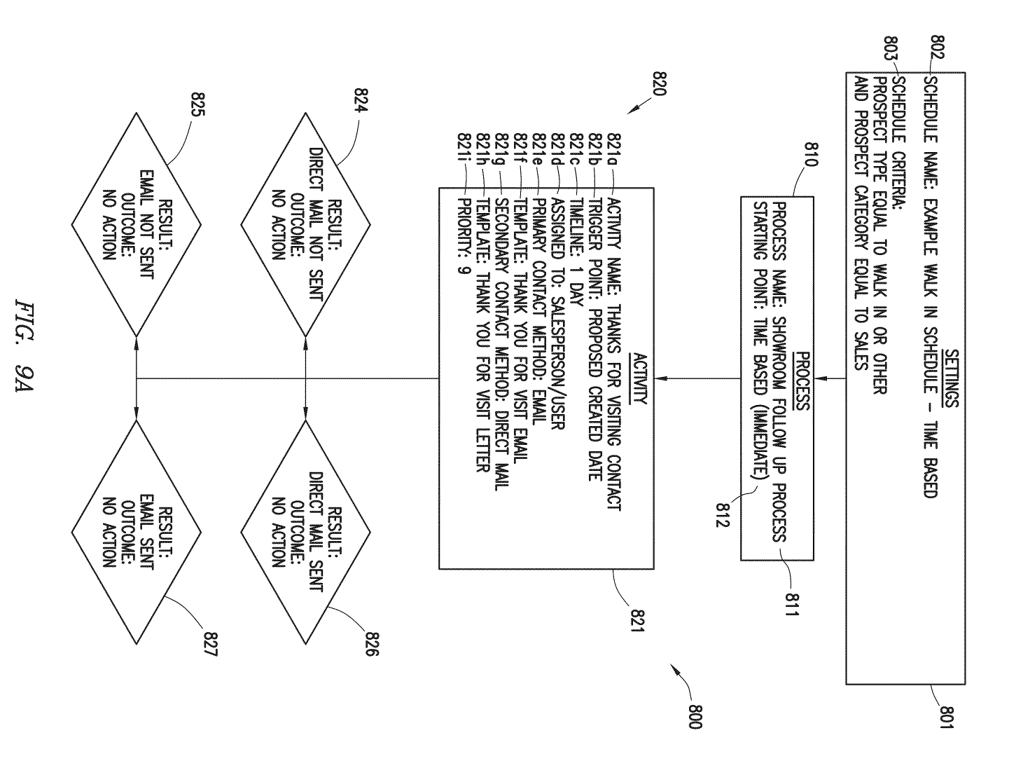

Once the prospect has been assigned in assign prospect 110, a follow-up activity may be created in generate follow-up activity 120. A follow-up activity is an activity determined by computer algorithm that assigned to the dealership employee to which the prospect was assigned in assign prospect 110 or to another dealership employee. In certain embodiments of the present disclosure, the follow-up activity may be determined by computer algorithm based on one or more results-based schedules. As used herein, a results-based schedule is a schedule in which the follow-up activity is determined based at least in part on the results of an interaction between the dealership and/or its employees and the client. The results-based schedules may be stored in a non-transitory, tangible computer readable storage medium. A follow-up activity may include, for instance and without limitation, email, text, recorded voice of a dealership employee, or direct mail to a client, or a telephone call to a client. Also as used herein, a time-based schedule is a schedule in which the follow-up activity is determined only by the passage of time after an interaction between the dealership and/or its employees and the client. Use of results-based schedules may allow, for example and without limitation, dealership personnel, such as a sales person, to select or assign an appropriate next action to take with the client based on certain results. In some embodiments, the next action may be triggered depending on one or more results. The differences between a results-based schedule and a time-based schedule are illustrated in FIGS. 8 and 9.

Based on the results-based schedule, one or more follow-up activities may be created by a computer in assign-follow-up activity 130 as shown in FIG. 1. The follow-up activities may thereafter be assigned to a dealership employee, such as a salesperson. The salesperson may then take the action dictated by the results-based schedule in action 140, as shown in FIG. 1. The action taken by the dealership employee may be stored in a non-transitory, tangible computer readable storage medium.

FIG. 8 is a flow chart example of results-based schedule consistent with at least one embodiment of the present disclosure. FIG. 8 depicts example walk-in schedule—results based flow chart 800.

Example walk-in schedule—results based flow chart 800 includes settings block 801, process block 810, and flow chart blocks 820. Settings block 801 includes schedule name 802, which, as shown in FIG. 8, is “Example Walk-in Schedule—Results Based.” Also included in setting block 801 is schedule criteria 803. Schedule criteria 803 specifies criteria for when the results-based schedule depicted in FIG. 8 may be used. For instance, schedule criteria 803 in FIG. 8 are “prospect type equal to walk in or other” and “prospect category equal to sales.” “Prospect type,” as described above, may be walk-in, fax, list, phone, internet or other options, i.e., how the dealership was notified of the prospect. “Prospect category” is the schedule type for which the prospect is classified and may include client care, parts, prospect, ready for pickup, sales, service appointment and/or service ro. As one of ordinary skill in the art will appreciate with the benefit of this disclosure, other prospect categories may be specified.

FIG. 8 further includes process block 810. Process block 810 includes process name 811. Process name 811 is the name of the results-based schedule, which for FIG. 8 is “Showroom Follow-Up Process.” Process block 810 further includes starting point 812. Starting point 812 specifies at what point the results-based schedule in FIG. 8 will start. In certain embodiments, such as that shown in FIG. 8, starting point 812 is time-based. Results-based schedules having time-based starting points begin at a predetermined time, such as immediately (as shown in FIG. 8) or after a delay, such as a set number of days or weeks. Other starting points may be results-based, i.e., the results-based schedule starting point may depend upon the completion of an activity from a different results-based or time-based schedule.

Flow chart blocks 820, as shown in FIG. 8, include activity blocks 821, 822, and 823, and result blocks 824, 825, 826, 827, 828, 829, 830, 831, 832, 833, and 834 end. Activity blocks 821, 822, 823 include activities performed by the user as part of walk-in schedule—results based flow chart 800. As an example, activity block 821 includes activity name 821a. Activity name 821a is the name of the activity performed in activity block 821. Activity name 821a in block 821 is “Thanks for Visiting Contact.” Activity block 821 further includes trigger point 821b. Trigger point 821b describes the event that actuates the activity block, assuming that schedule criteria 803 are met. Trigger point 821b is “After—Prospect Created Date.” Activity block 821 further includes timeline 821c. Timeline 821c defines the time between when trigger point 821b is actuated and when the activity prescribed in activity block 821 is performed. Timeline 821c is one day. Activity block 821 also includes assigned to 821d. Assigned to 821d is as defined above. Assigned to 821d is “salesperson/user.” Activity block 821 further includes primary contact 821e. Primary contact 821e specifies the primary contact method with the client for the activity of the activity block. Examples of primary contact 821e may include, but are not limited to, email, text, recorded voice of a dealership employee, or direct mail, or in person communication. Primary contact 821e in activity block 821 is “Email.” Activity block 821 also includes template 821f corresponding to primary contact 821e. Template 821e specifies the template for the communication for the primary contact method of communication with the client. Template 821f in activity block 821 is “Thank You For Visit Email.” Activity block 821 additionally includes secondary contact method 821g. Secondary contact 821g specifies a secondary contact method with the client for the activity of the activity block in the event that the primary contact method is not available or undesirable. Examples of secondary contact 821g may include, but are not limited to, email, text, recorded voice of a dealership employee, or direct mail, or in person communication. Activity block 821 also includes secondary template 821h, labelled “Template” in FIG. 8. Secondary template 821h specifies the secondary template for the communication for the secondary contact method of communication with the client. Secondary template 821h in activity block 821 is “Thank You For Visit Letter.” Template 821e and secondary template 821h may be fillable documents such as emails or online documents customizable by the user for the prospect and/or client. In certain embodiments of the present disclosure, template 821e and secondary template 821h may be stored in a database accessible to the user. Activity block 821 also includes priority 821i. In certain embodiments, multiple follow-up activities may be targeted at a client. In these embodiments, a computer-run rules engine may designate that a client may receive only a certain number of communications in a given time period. Which communications are sent to a client may depend in part on the priority assigned to the communication. Priority 821i may designate the communication resulting from a particular activity, such as that from activity block 821 with a numbered priority. In some embodiments, the activity priorities are ordered such that “1” is the highest priority and are ranked therefrom.

Flow chart blocks 820 include result blocks 824, 825, 826, and 827, which are result blocks from activity block 821. As shown in FIG. 8, if email (result block 825) or direct mail (result block 824) is not sent, the user is prompted to begin the results-based activity in activity block 823, i.e., “Penny For Your Thoughts Contact” through not sent results-based outcome 834. As further shown in FIG. 8, if email (result block 827) or direct mail (result block 826) is sent, the user is prompted to begin the results-based activity in activity block 822, i.e., “Showroom Followup Call.” Activity block 823 includes trigger point 823b. Trigger point 823b is “activity result,” i.e., the trigger point is based on a results based activity, which, with respect to FIG. 8, is whether result block 825 or 824 indicate that the email or direct mail from activity block 821 was not sent.

With further direction to FIG. 8, with respect to activity block 823, if direct mail (result block 828) or mail (result block 829) is not sent, the activity in activity block 823 is repeated as shown by repeat activity 836. If direct mail (result block 830) or email (result block 831) is sent as a result of activity block 823, the user is prompted to begin the results-based activity in activity block 822, i.e., “Showroom Followup Call” by prompt activity block 837. Activity block 822 includes trigger point 822b. Trigger point 822b is “activity result,” i.e., the trigger point is based on a results based activity, which, with respect to FIG. 8, is whether result block 830 or 831 indicate that the email or direct mail from activity block 823 was sent. Result blocks 832 (call back outcome: reschedule activity) and 833 (did not talk to customer) prompt the user to repeat the activity in activity block 822. Result block 834 end (bought elsewhere) ends walk-in schedule—results based flow chart 800.

FIG. 9 is similar to FIG. 8, but is directed to a time-based, not results-based, activity. Therefore, activities by the user do not prompt the user to conduct additional activities. Instead, trigger points for activity blocks 822 and 823 are entirely time-based, not results-based. As depicted in FIG. 9, if email (result block 825) or direct mail (result block 824) is not sent, the user is not prompted to begin the results-based activity in activity block 823, i.e., “Penny For Your Thoughts Contact” as not sent results-based outcome 834 is not present in FIG. 9. Instead, trigger point 823b is “After-Prospect Created Date” instead of “Activity Result” as in FIG. 8. Further as depicted in FIG. 9, if email (result block 827) or direct mail (result block 826) is sent, the user is not prompted to begin the results-based activity in activity block 822, i.e., “Showroom Followup Call.” Instead, regardless of which result block 824, 825, 826, or 827 results from activity block 821, no further action is prompted.

Additionally, as shown in FIG. 9, with respect to activity block 823, if direct mail (result block 828) or mail (result block 829) is not sent, the activity in activity block 823 is not repeated. Further, with respect to activity block 823, direct mail (result block 830) or email (result block 831) is sent as a result of activity block 823, the user is not prompted to begin the results-based activity in activity block 822, i.e., “Showroom Followup Call.”

Further, as shown in FIG. 9, with respect to activity block 822, result blocks 832 (call back outcome: no activity) and 833 (did not talk to customer) do not prompt the user to repeat the activity in activity block 822, but instead result in no additional action. Result block 834 end (bought elsewhere) further results in no action.

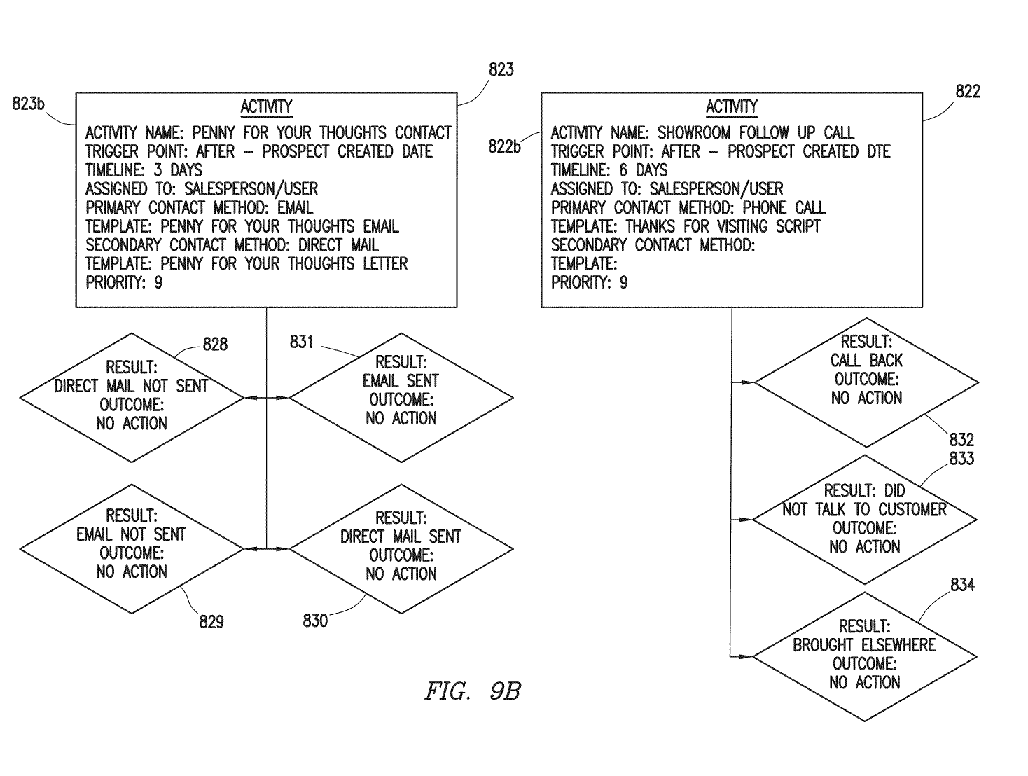

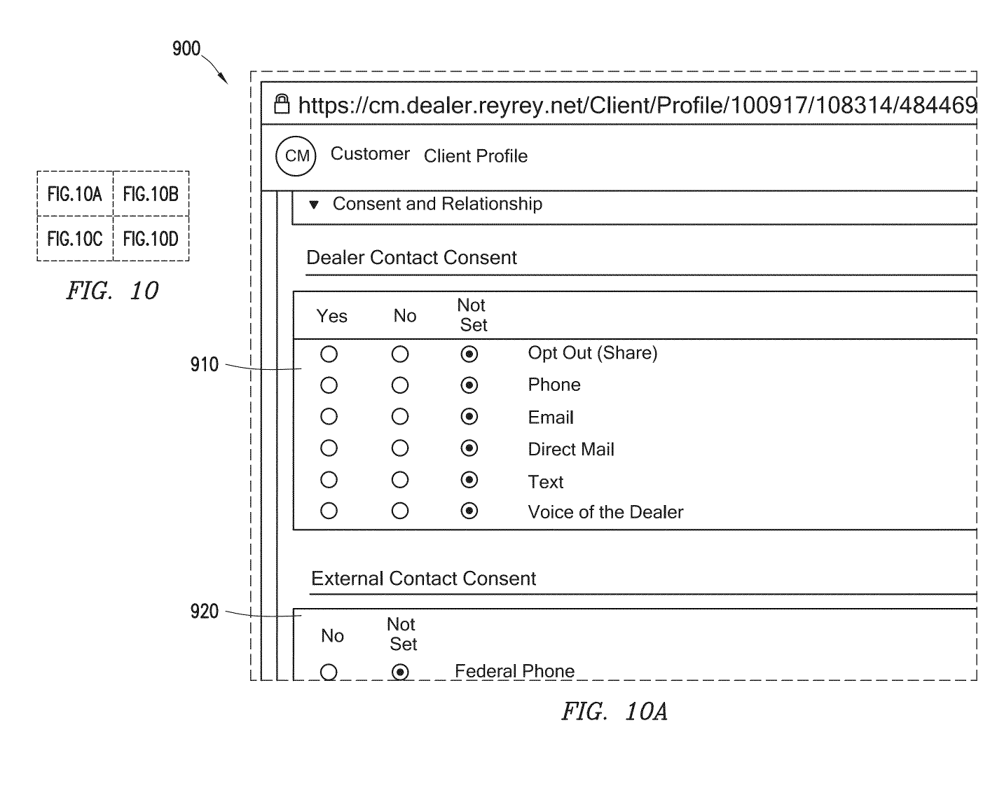

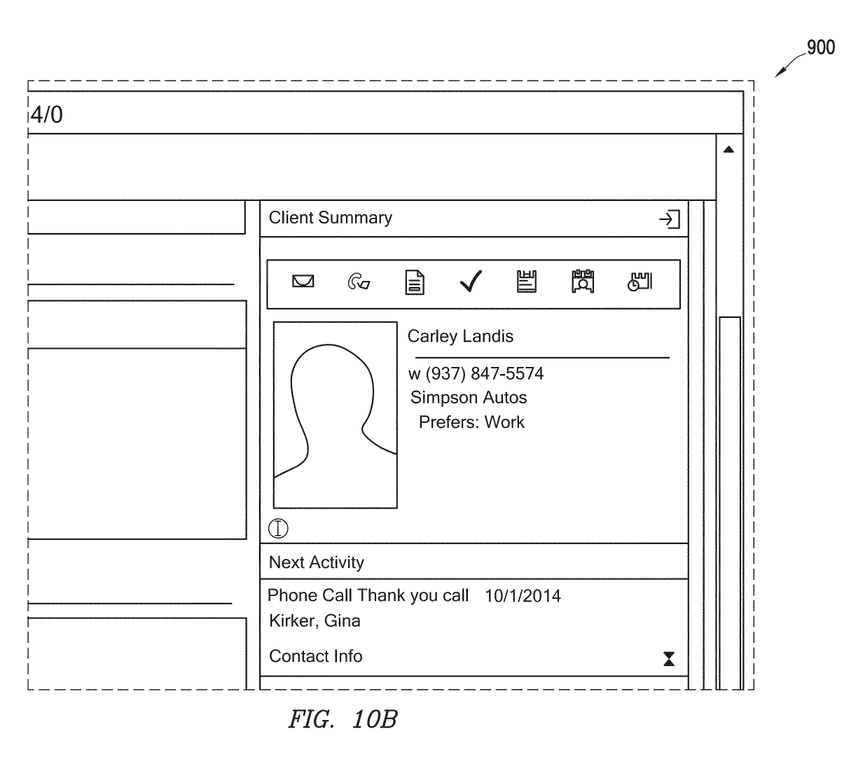

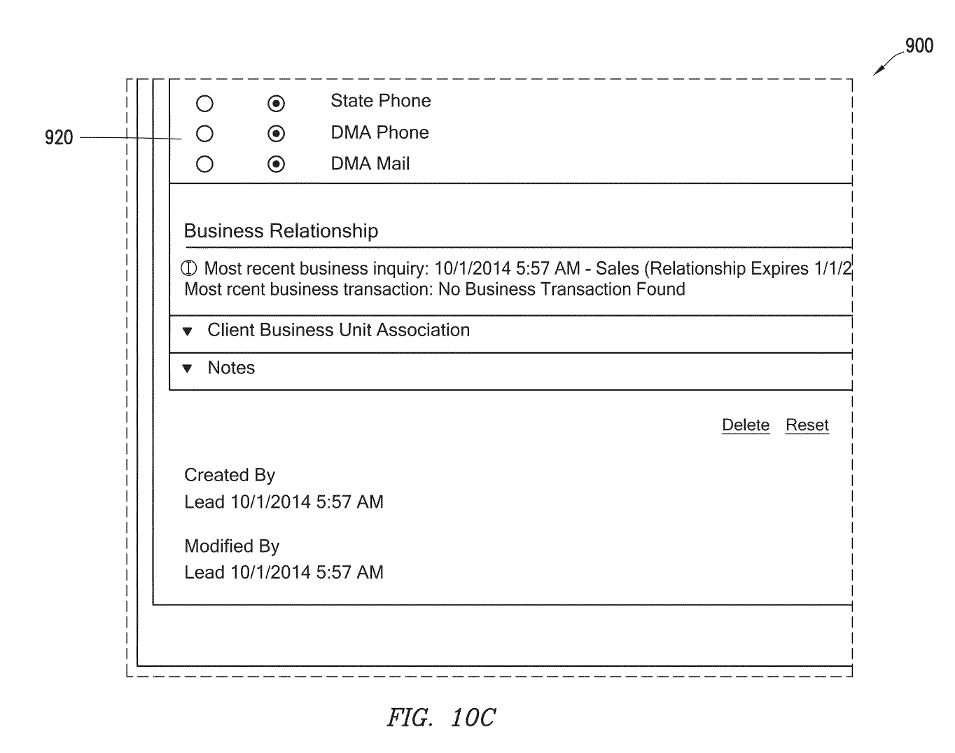

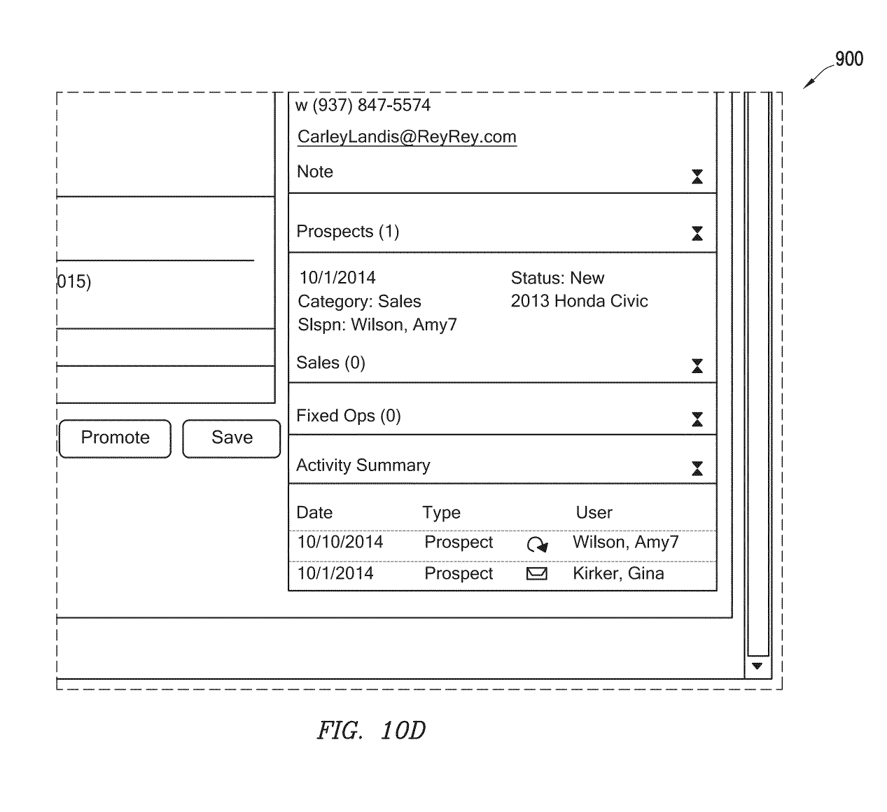

In certain embodiments of the present disclosure, client privacy preferences may be identified for each client. For instance, privacy preferences such as Federal and State Do Not Call flags and contact consent for e-mail, mail and third party data sharing may be identified or tracked for a client. Based on the identified privacy preferences, the results-based schedules may be modified. The results-based schedules in generate follow-up activity 120 may then modify the follow-up activity based on client preference. In some embodiments, as depicted in FIG. 10, customer contact GUI 900 allows dealership employees to set a client's restrictions regarding contact by dealership employees, such as agreeing or not agreeing to phone, e-mail, direct mail, text or voicemail from the dealer, as shown in direct contact consent settings 910. Customer contact GUI further allows Federal and State Do Not Call Flags to be set, as shown in external contact consent settings 920

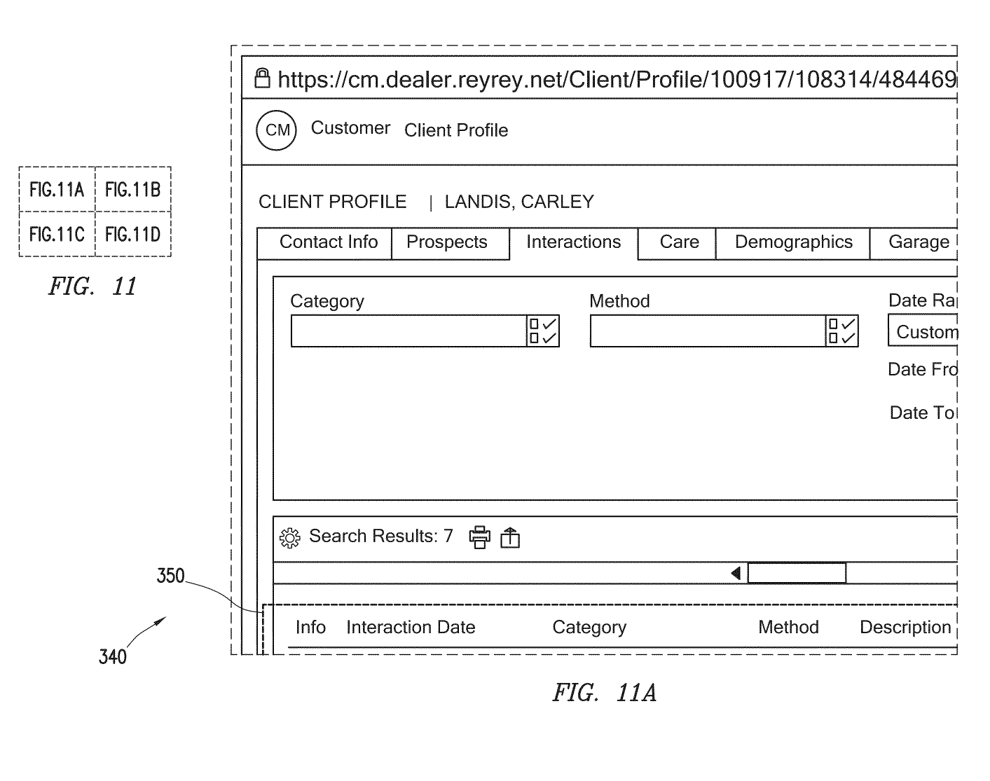

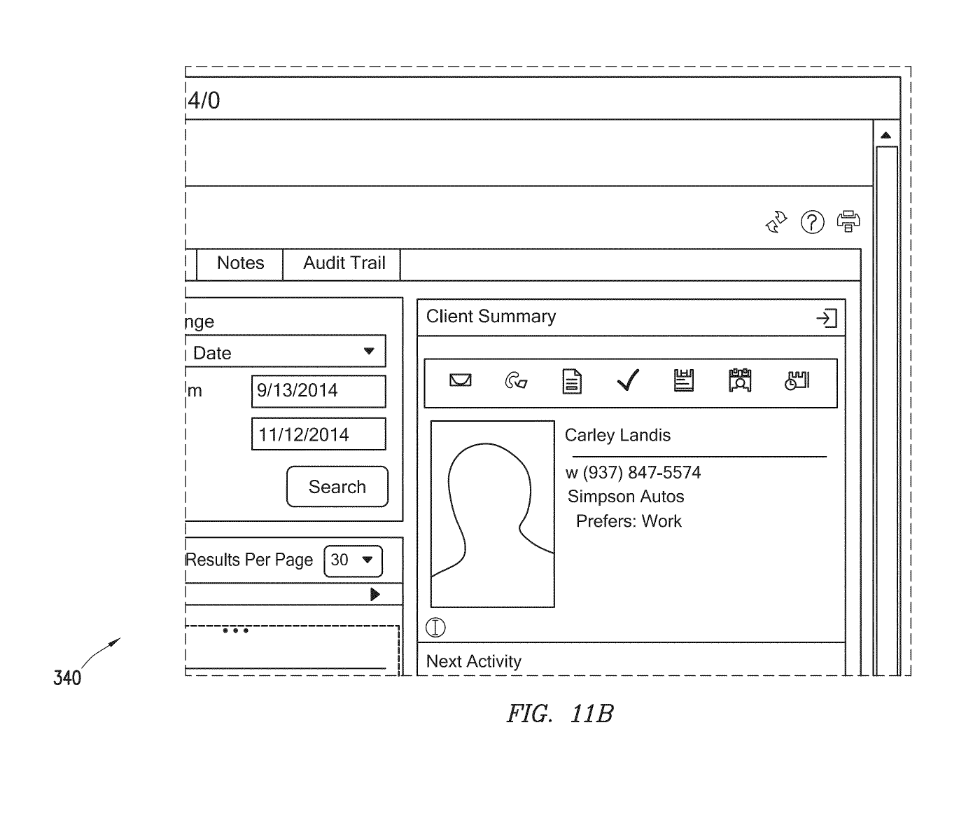

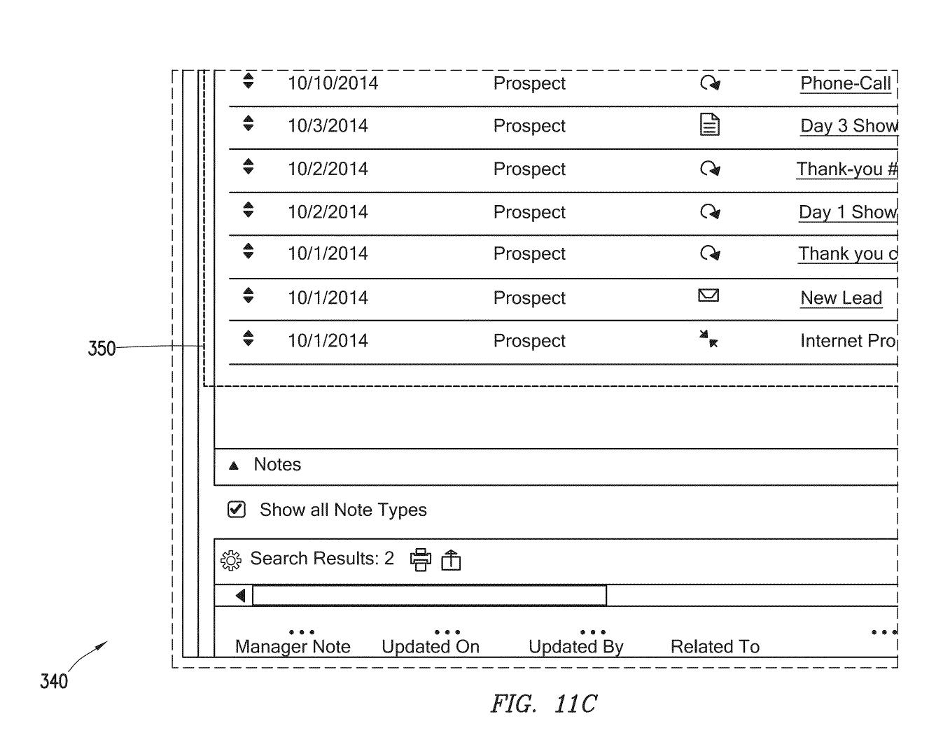

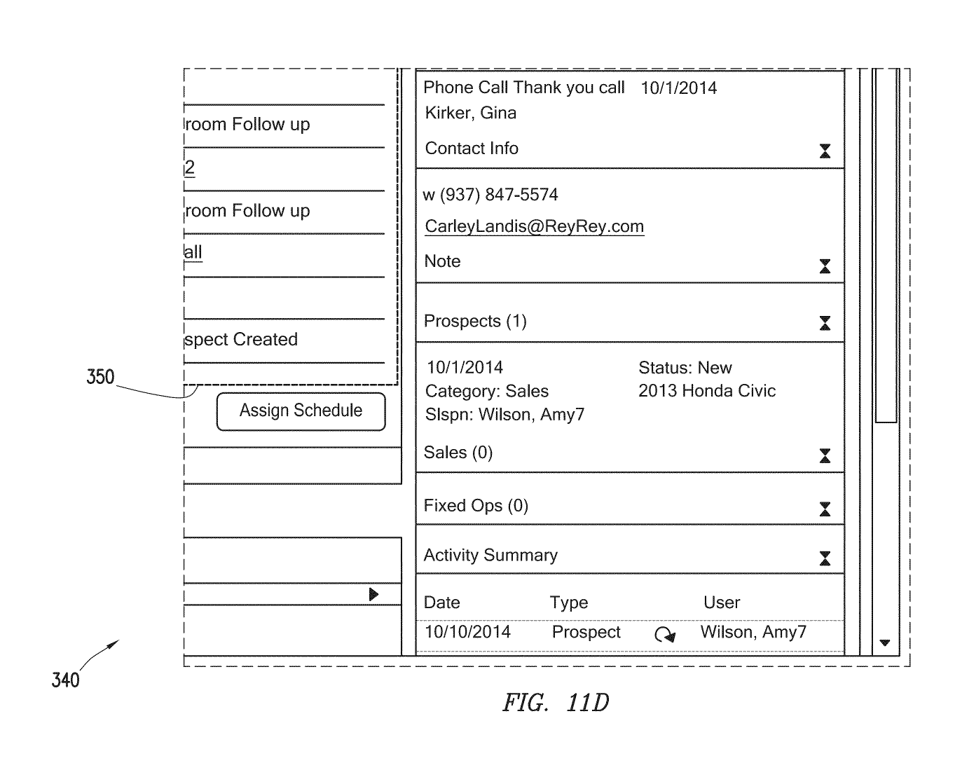

In certain embodiments, as part of action 140, all interactions with the client may be logged. A log may, for instance, be included as part of the client profile. As shown FIG. 11, client profile interactions GUI 340 may display interaction 350 description, which may include such non-limiting information as the interaction date, the category of the client, the method used in the interaction and the description of the interaction for a particular client.

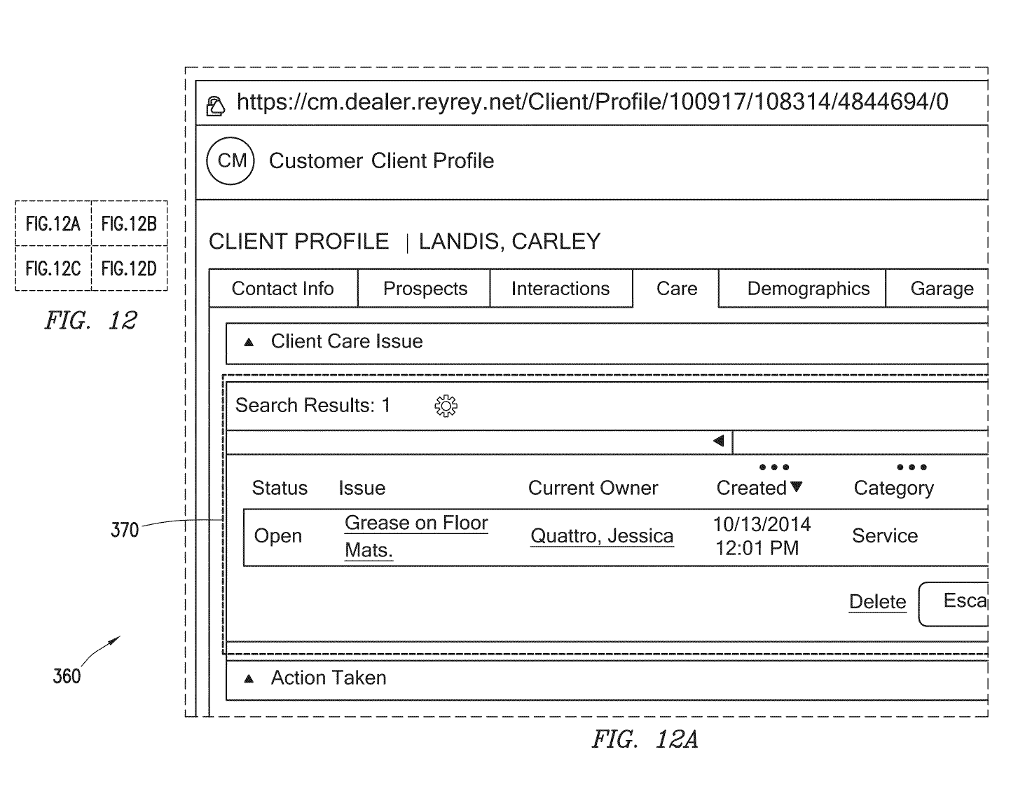

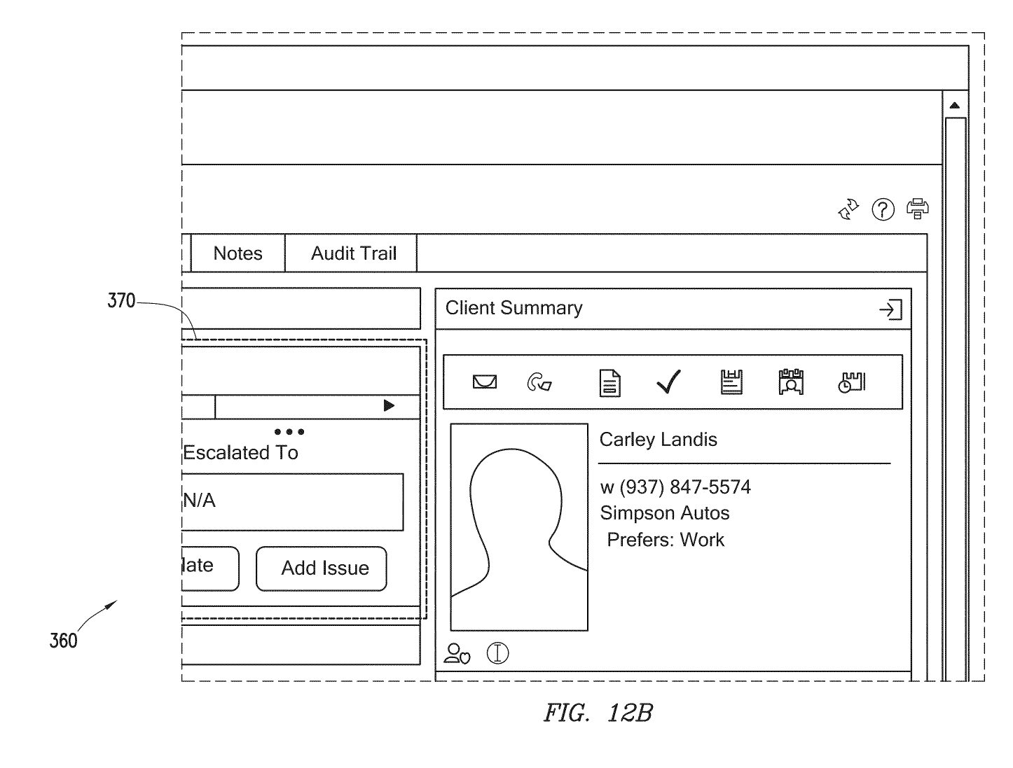

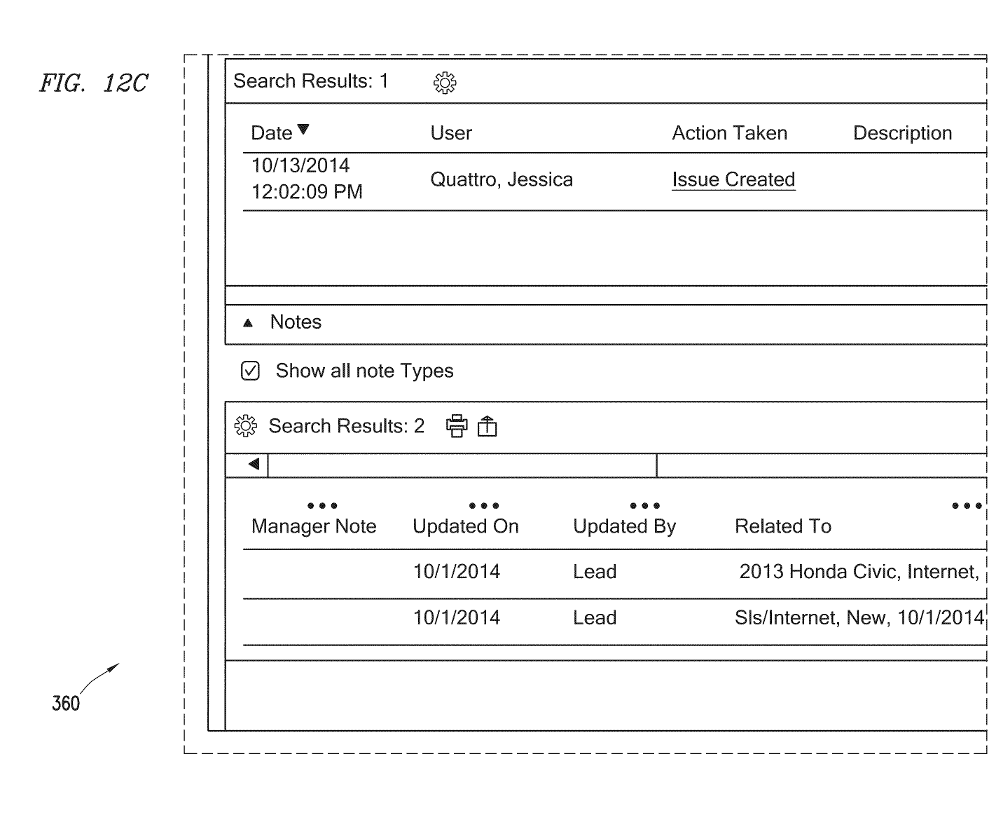

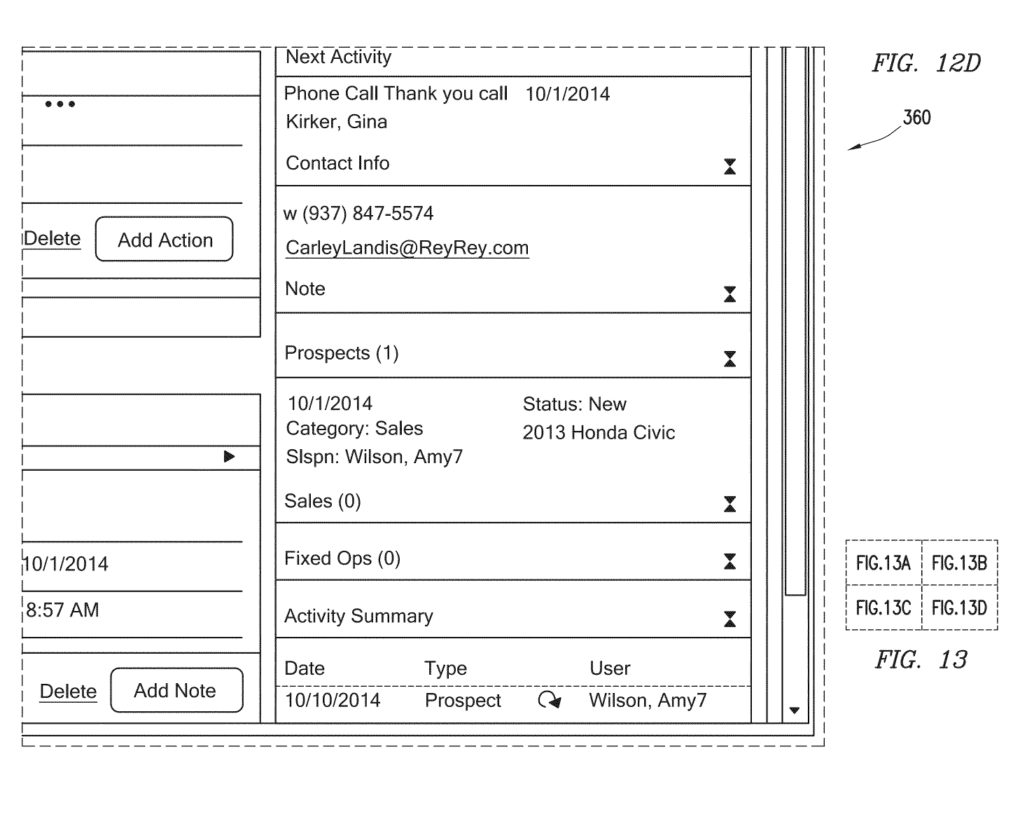

Generate follow-up activity 120 may be customized for particular clients based, for example, on interactions with the client. For instance, a negative interaction between the client and the dealership or one of its employees, may generate a client care issue that may be logged and displayed as part of the client profile. In some embodiments, as shown in FIG. 12, client profile client care GUI 360 may be utilized to display such information. Client profile client care GUI 360 may include a client care description 370 of the interaction between the client and the dealership or one of its employees. Client care description 370 may include such information as the status, the issue, the current owner of the follow-up activity, when the incident occurred or was entered into client profile client care GUI 360 and other information related to the interaction.

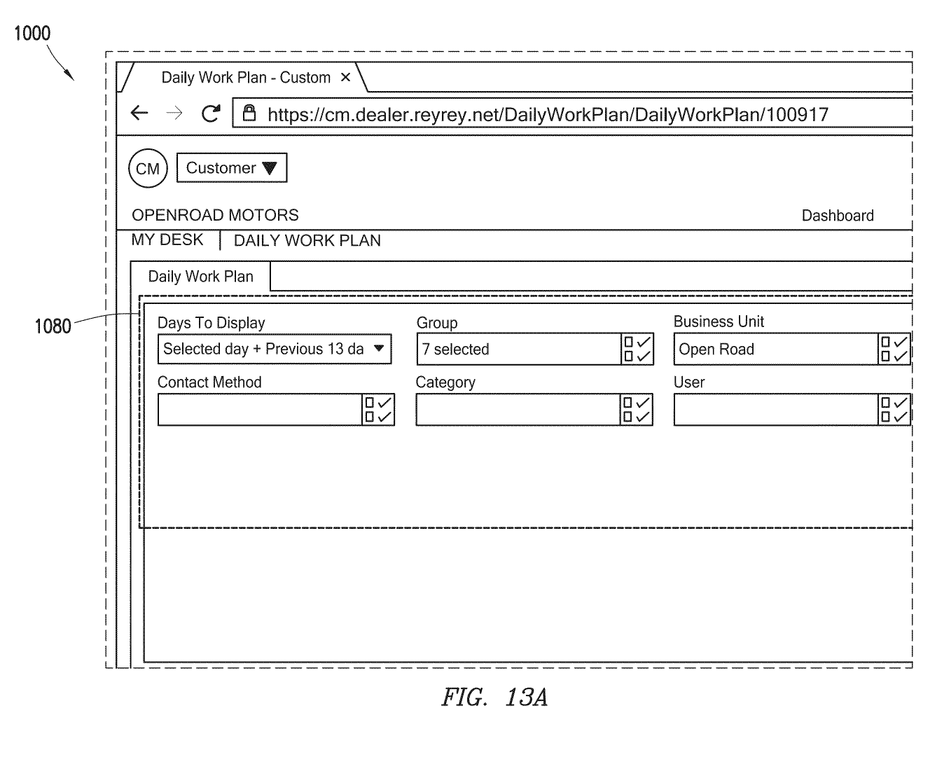

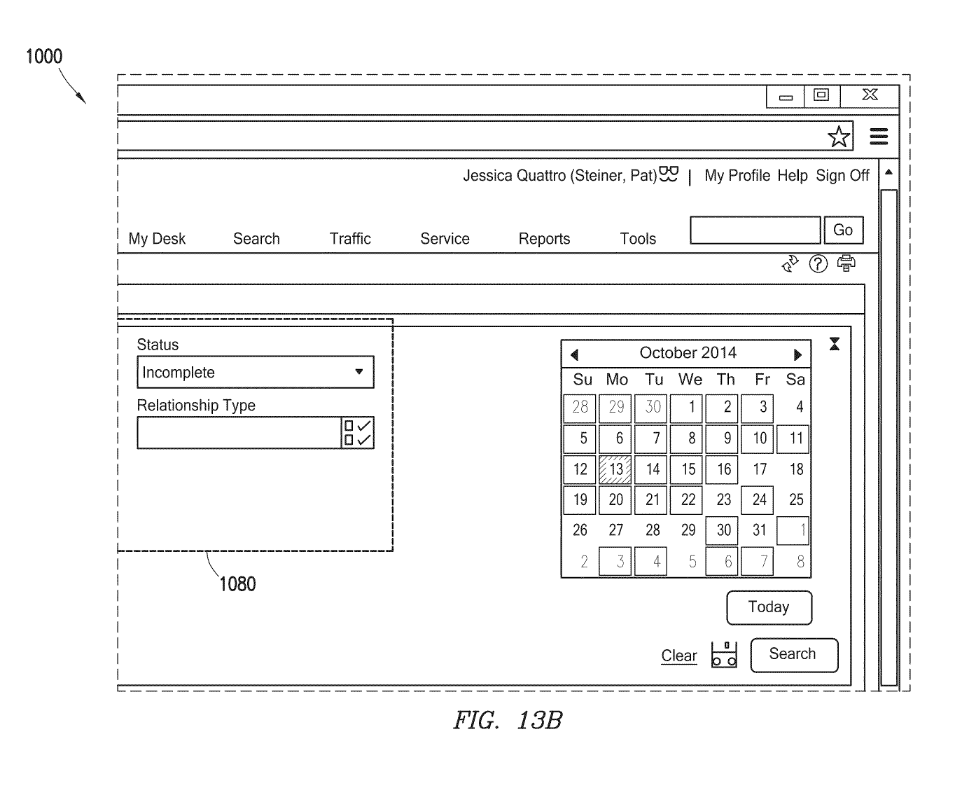

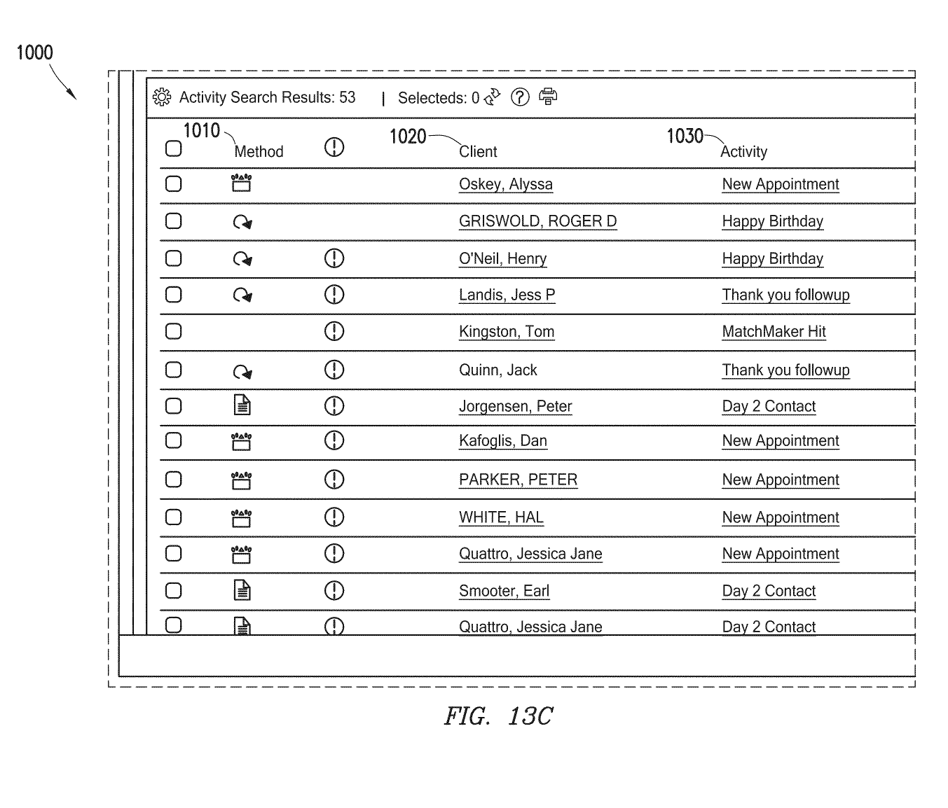

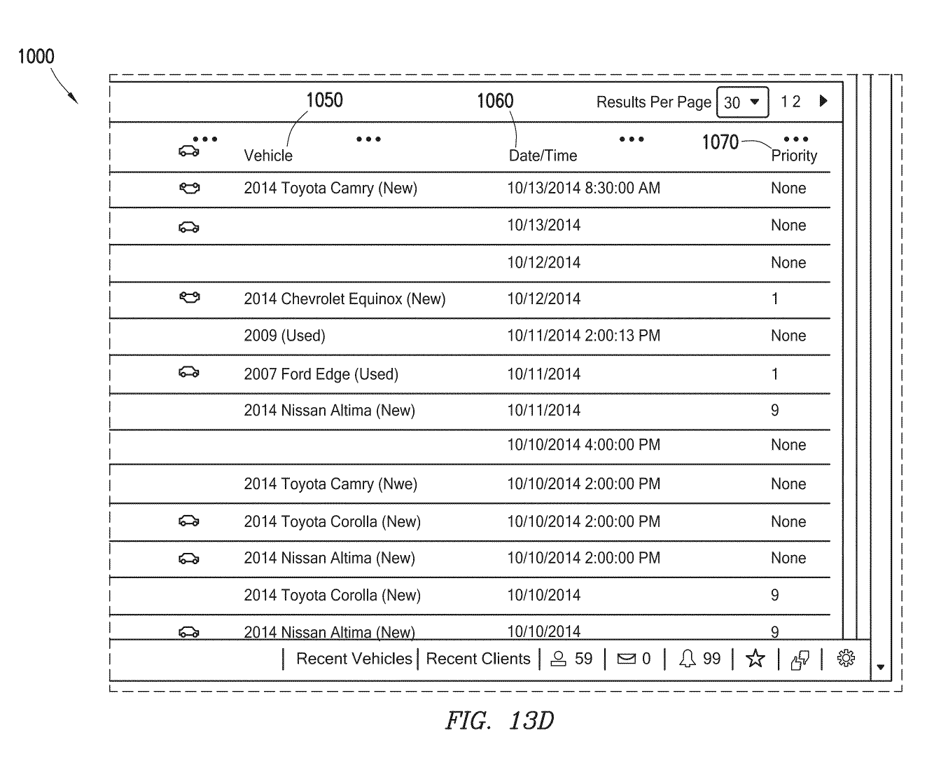

In some embodiments, actions 140 may be aggregated into a work plan for a particular user. FIG. 13 depicts daily work plan GUI 1000. Daily work plan GUI 1000 may show for a given day the actions 140 assigned to a dealership employee, such as a salesperson. Daily work plan GUI 1000 may display information including, for example and without limitation, action method 1010, action client 1020, action activity 1030, action equity 1040, action vehicle 1050, action date/time 1060 and action priority 1070. Other action information may include overdue, privacy, BDC User, category, click to call for manager, click to call for salesperson/user, score, secondary salesperson/user, source, and/or status. As one of ordinary skill in the art will appreciate, daily work plan GUI 1000 may instead be fashioned as a weekly or monthly plan. Further, in certain embodiments of the present disclosure, daily work plan actions may be filtered by daily work plan filters 1080. Non-limiting examples of such daily work plan filters 1080 are depicted on daily work plan GUI 1000, and may include days to display, group, business unit, status, contact method, category, and user.

In certain embodiments of the present disclosure, equity 1040 may be calculated for the client's potential trade-in based on information in an external database or provided by the client. The potential trade-in equity may be determined based on such criteria as payments on the vehicle, sales and deal factors, as well as service history and estimated mileage. For example, as shown in FIG. 13, equity 1040 may depict an upside down vehicle when the client has negative equity in the potential trade-in vehicle and a right-side up vehicle when the client has positive equity in the potential trade-in vehicle.

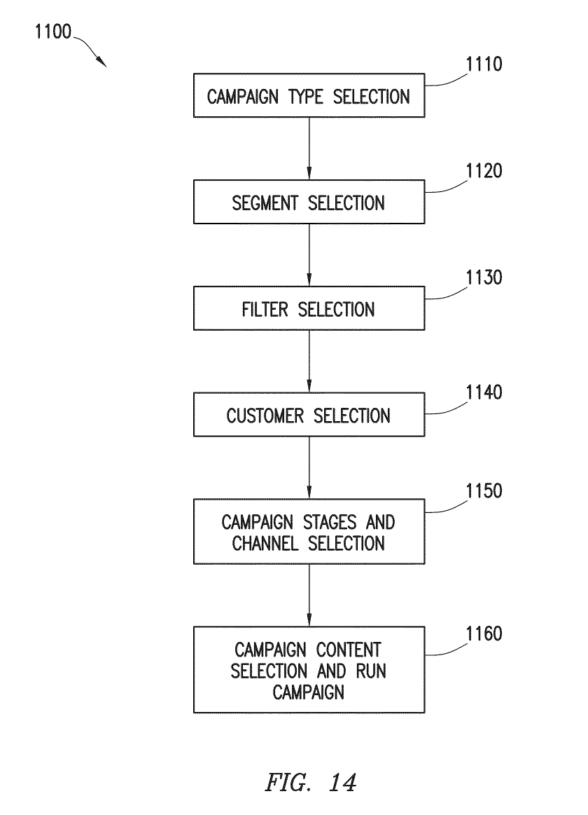

In other embodiments of the present disclosure, prospects may be created through the use of a campaign. For purposes of this disclosure, a “campaign” is a process through which prospects may be contacted from a campaign initiator. In a campaign, prospects may be created by contacting potential clients through such means as telephone, e-mail, direct mail, or social media. As depicted in FIG. 14, in some embodiments of the present disclosure, campaign generation system 1100, may include the operations of campaign type selection 1110, segment selection 1120, filter selection 1130, customer selection 1140, campaign stages and channel selection 1150 and campaign content selection and run campaign 1160. As one of ordinary skill in the art will appreciate with the benefit of this disclosure, while FIG. 14 depicts campaign generation system 1100 including all of campaign type selection 1110, segment selection 1120, filter selection 1130, customer selection 1140, campaign stages and channel selection 1150 and campaign content selection and run campaign 1160, certain embodiments of the present disclosure may omit one or more of campaign type selection 1110, segment selection 1120, filter selection 1130, customer selection 1140, campaign stages and channel selection 1150 and campaign content selection and run campaign selection 1160.

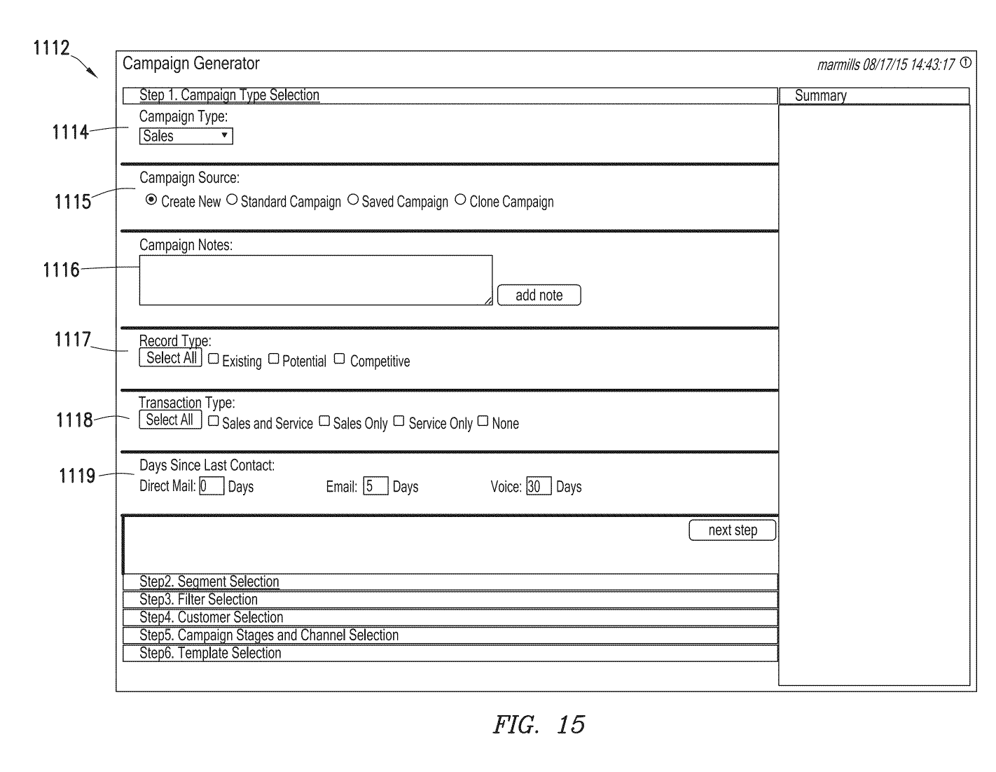

In campaign type selection 1110, certain aspects of the campaign may be selected. For instance, in certain embodiments, such as the embodiment depicted in FIG. 15, aspects of the campaign in campaign type selection 1110 may be selected through campaign type selection GUI 1112. Campaign type selection GUI 1112 may include a campaign type selector 1114. Examples of campaign types selectable through campaign type selector 1114 may include campaigns directed to sales or service prospects. Campaign type selection GUI 1112 may also include campaign source selector 1115. Examples of campaign sources available through campaign source selector 1115 may include create new campaign, use a standard campaign, retrieve a saved campaign or clone a previous campaign. Campaign type selection GUI 1112 may include campaign notes field 1116 where notes about the campaign may be entered. Campaign type selection GUI 1112 may include target audience selection 1117. Examples of target audience prospects selectable in target audience selection 1117 (entitled “record type” on FIG. 15) may include existing customers, potential customers, or customers of competitors. In certain embodiments of the present disclosure, clients of competitors may only be targeted by direct mail campaigns. Campaign type selection GUI 1112 may include transaction type 1118. Transaction type 1118 may specify the transaction history of the target audience prospects including, but not limited to, sales and service, i.e. prospects with a currently owned vehicle that have had both a sales and service transaction with the dealership, sales only, i.e., prospects with a currently owned vehicle that have had only sales transactions with the dealership, and service only, i.e., prospects with a currently owned vehicle that have had only service transactions with the dealership or households without a currently owned vehicle (entitled “none” in FIG. 15). Campaign type selection GUI 1112 may include days since last contact 1119. In days since last contact, the campaign may be tailored to only contact prospects that have had a determined period of time elapse since last contacted. Days since last contact 1119 may be adjusted based on whether the campaign is telephonic, e-mail, direct mail, or through social media. Days since last contact may be 30 days, 21 days, 14 days, 5 days, 0 days, or other number of days selected. Campaign type selection GUI 1112 may have pre-determined minimum number of days since last contact, such as 0 days for direct mail, 5 days for e-mail, and 30 days for telephone contact, although these are merely examples and pre-determined minimum number of days may be altered as needed or desired.

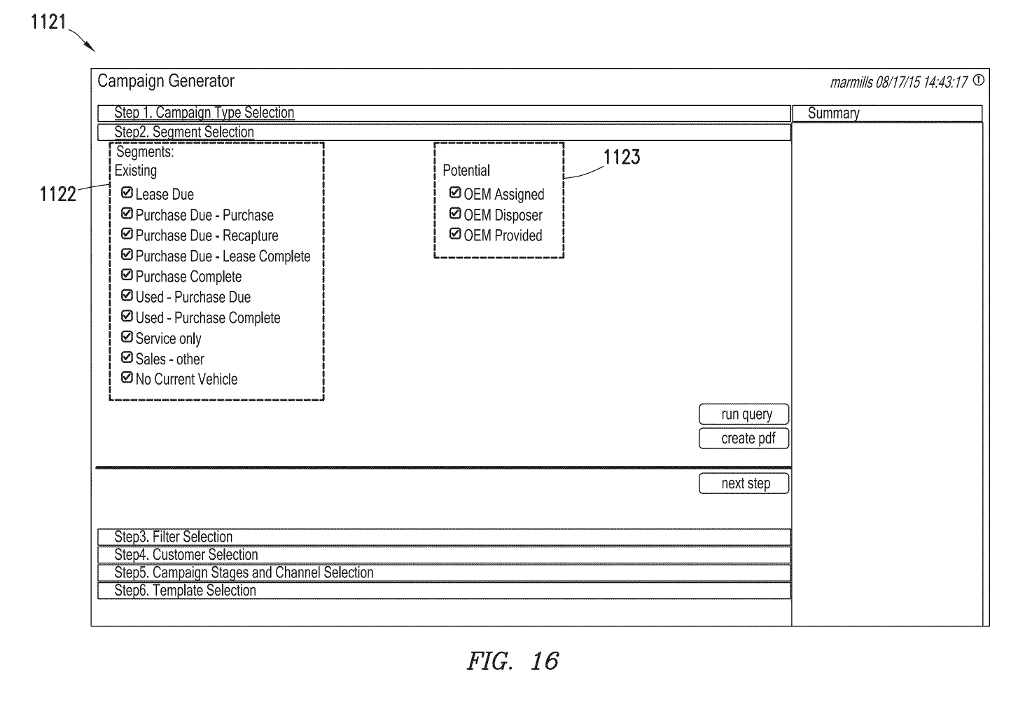

In segment selection 1120, selections made in campaign type selection 1110 may be designated on the basis of grouping of prospects based on service history or purchase history. In certain embodiments, such as that depicted in FIG. 16, aspects of the campaign in segment selection 1120 may be selected through segment selection GUI 1121. For example, target audience prospects selected in target audience selection 1117 (entitled “record type” on FIG. 15), such as existing clients and potential clients, may be limited through segment selection 1120 to particular existing clients or potential clients based on particular segments. As shown in FIG. 16 in segment selection GUI 1121, existing clients may be further restricted through selection in existing customer user interface selector 1122 based on such criteria as lease due, purchase due—purchase, purchase due—recapture, purchase due—lease complete, purchase complete, used—purchase due, used—purchase complete, service only, sales-other, and no current vehicle. Lease due refers to prospects having with a vehicle on an active lease. Purchase due—purchase refers to prospects with a vehicle purchased new that are in the market to buy a vehicle. Purchase due—recapture refers to prospects not known to have purchased a vehicle from the dealership, who have purchased elsewhere and are in the market to buy again. Purchase due lease complete refers to prospects who purchased a vehicle at lease termination and are in the market to buy again. Purchase complete refers to prospects who have paid off vehicle purchased new. Used—purchase due refers to prospects who purchased a used vehicle from the dealership and are in the market to buy. Used—purchase complete refers to prospects who have paid off a used vehicle purchased from the dealership. Service only refers to prospects who have not purchased from the dealership but have had service done on the vehicle by the dealership. No current vehicle refers to prospects for which the dealership has no record of having a vehicle.

As further shown in FIG. 16, prospects for the campaign may be further or otherwise designated through selection of potential customer user interface selector 1123 based on such criteria as Original Equipment Manufacturer (“OEM”) assigned prospects, i.e., records assigned to a dealership when a nearby dealership closed or prospects who purchased from a different dealership and now live within the dealership's OEM assigned primary market area (PMA), OEM disposer customers, i.e., prospects that purchased a vehicle from the dealership and subsequently disposed of it, and OEM provided, i.e., prospects supplied by the dealership's OEM for any other reason, such as customers for whom there has been no record of vehicle purchase for a set number of years.

In filter selection 1130, selections made in campaign type selection 1110 may be designated based on certain client vehicle criteria. In certain embodiments, such as the embodiment depicted in FIG. 17, aspects of the campaign related to the client vehicle criteria in filter selection 1130 may be selected through filter selection GUI 1131. Filter selection 1130 may include such client vehicle criteria as vehicle year, vehicle make, vehicle model, vehicle sale type, vehicle condition, vehicle type, purchase date of the vehicle, service date of the vehicle, vehicle contract termination date, mileage of the vehicle, estimated mileage of the vehicle, and VIN of the vehicle. Such client vehicle criteria are examples and other vehicle criteria may be included in filter selection 1130.

Filter selection GUI 1131 may include vehicle interface selections 1132. A user may enter or select details regarding the client vehicle through vehicle interface selections 1132. In certain embodiments, vehicle interface selections 1132 may include global vehicle criteria interface 1133. Global vehicle criteria interface 1133 may have such options as “all,” “include,” or “exclude.” Selection of “all” has the effect of selecting a vehicle with any criteria for the campaign. For instance, if the vehicle criteria selected were vehicle year and “all” were selected, all vehicle years would be included in the campaign. “Include” has the effect of including only the vehicle criteria selected for the campaign and “exclude” has the effect of excluding the vehicle criteria selected from the campaign.

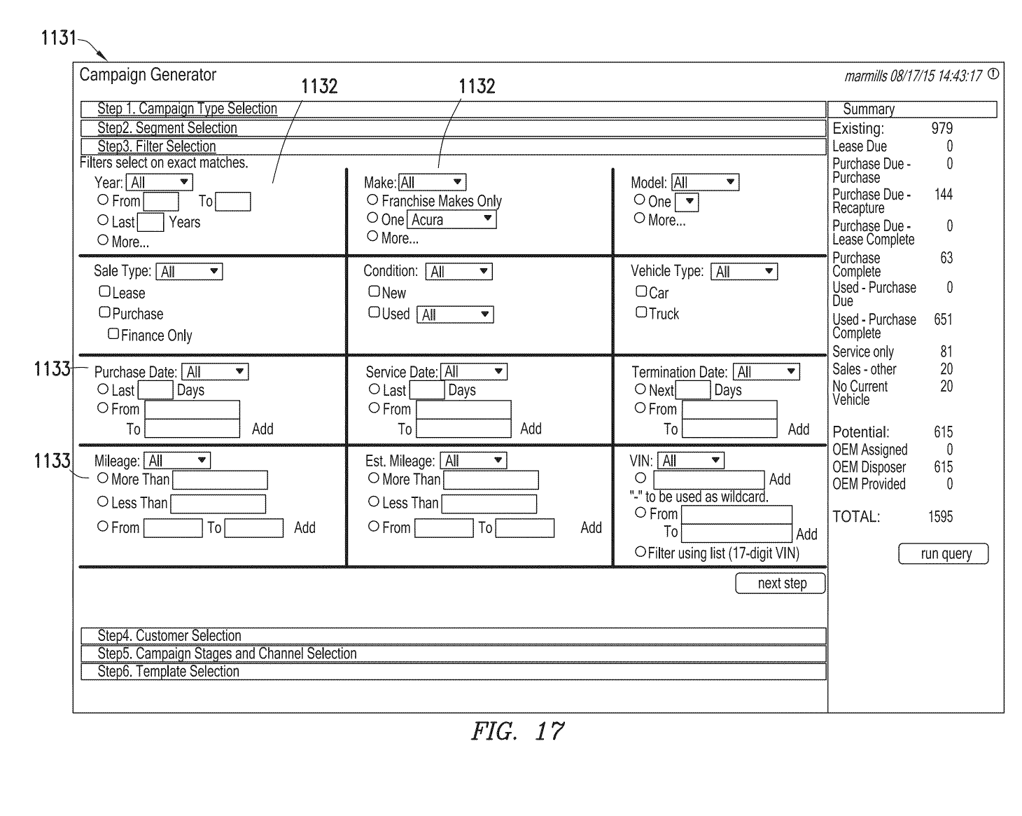

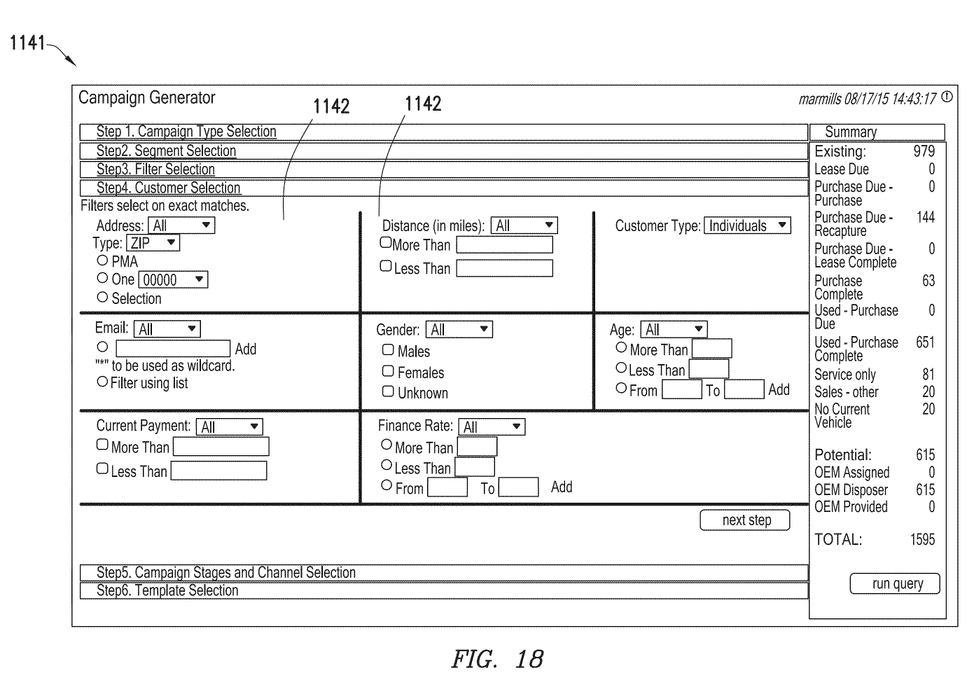

In customer selection 1140, selections made in campaign type selection 1110 may be designated based on certain client criteria. In certain embodiments, such as the embodiment depicted in FIG. 18, aspects of the campaign related to the client in customer selection 1140 may be selected through customer selection GUI 1141. Customer selection 1140 may include such client criteria as client address, the distance of the client's address from the dealership, customer type (such as individual or company), e-mail address or e-mail address type, gender, age, current payment, and finance rate. Such client criteria are examples and other client criteria may be included in client selection 1140. A user may enter or select details regarding the client through client interface selections 1142. In certain embodiments, client interface selections 1142 may include global client criteria interface 1143. Global client criteria interface 1143 may have such options as “all,” “include,” or “exclude.” Global client criteria interface 1143 operate as described above with respect to global vehicle criteria interface 1133.

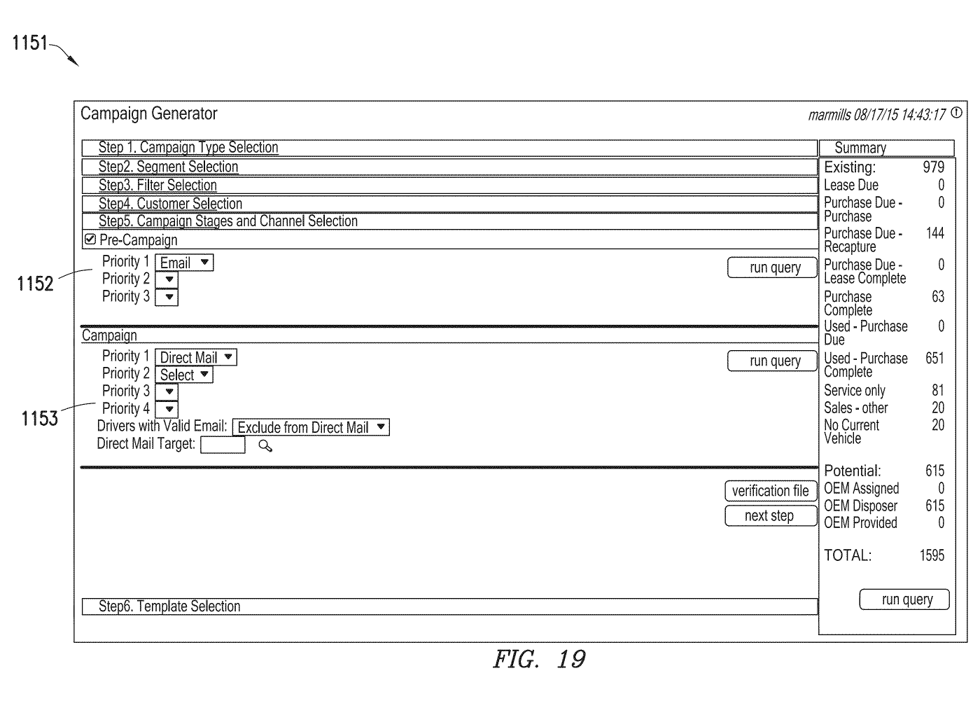

In campaign states and channel selection 1150, details regarding the campaign may be specified. In certain embodiments, a pre-campaign may be specified to precede the campaign. A pre-campaign may be sent to prospect to alert the prospect to an upcoming campaign. The determination of whether to create a pre-campaign may be made in campaign states and channel selection 1150. Further, during campaign states and channel selection 1150, the channel used to contact prospects may be specified. As discussed above, channels for campaigns may include, but not be limited to social media, e-mail, direct mail, text, and telephone. Details regarding campaign states and channel selection 1150 may be specified in campaign states and channel selection GUI 1151, as shown in FIG. 19. For instance, whether to include pre-campaign may be specified in pre-campaign interface 1152. Details regarding the campaign may be specified in campaign interface 1153. Pre-campaign interface 152 and campaign interface 1153 may be used, as shown in FIG. 19, to specify the channels for the pre-campaign and campaigns, respectively, as well as alternate channels for each of the pre-campaign and campaign. These alternate channels may be prioritized through pre-campaign interface 152 and campaign interface 1153.

In campaign content selection and run campaign 1160, the actual content of the campaign may be created. Examples of such content may include sales promotions, service promotions, and lease promotions. Following the creation of the campaign content, the campaign is executed in campaign content selection and run campaign 1160, i.e., prospects are contacted by telephone, e-mail, direct mail, text, or through social media with the subject content.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A method comprising:
(a) assigning a prospect, the prospect associated with a vehicle;
(b) generating a follow-up activity for the prospect, the follow-up activity being determined by a results-based schedule.
(c) assigning the follow-up activity to a user;
(d) carrying out the follow-up activity by the user to generate at least one result; and
(e) repeating steps (b)-(d) based at least in part on the result.

2. The method of claim 1, wherein the prospect is further associated with a client.

3. The method of claim 2, wherein the step of assign a prospect further includes receiving information from input devices and databases representing a client profile.

4. The method of claim 3, wherein information from input devices is entered through a client profile graphical user interface (“GUI”).

5. The method of claim 3, wherein the client profile may include one or more of the client's name, address, or contact information.

6. The method of claim 1, wherein the step of assign a prospect includes displaying a prospect on a computer using a my desk prospects GUI, the my desk prospects GUI adapted to display information about the prospect, the information comprising at least one of the client, business unit, prospect, the prospect vehicle identification, the date the prospect was created, the user responsible for the prospect, the status of the prospect, the last activity with respect to the prospect, the next activity with respect to the prospect or combinations thereof.

7. The method of claim 6, wherein the source of the prospect is displayed on my prospects GUI, the source being one of internet, radio, television, social media, Internet and billboard.

8. The method of claim 6, wherein my desk prospects GUI is adapted to display multiple prospects.

9. The method of claim 8, wherein the multiple prospects are displayed in a list.

10. The method of claim 9, wherein my desk prospects GUI displays the prospects assigned to a particular user.

11. The method of claim 9, wherein the prospects are selectively displayable based on one or more filters selected by the user.

12. The method of claim 2, wherein step (a) further comprises determining if the client is a duplicate client entry.

13. The method of claim 1, wherein the follow-up activity is generated based at least in part on a deal request, internet lead, demo drive, calling the customer, sending the customer an e-mail, or sending the customer a letter.

14. The method of claim 1, wherein the follow-up activity is generated based at least in part on a client privacy preference.

15. The method of claim 14, wherein the client privacy preference comprises at least one of a do not call flag, a consent to be contacted by the client, or a preferred contact method.

16. The method of claim 15, wherein the contact method includes email, phone, direct mail, text, or voice of a dealer.

17. The method of claim 1, wherein the follow-up activity is generated based at least in part on interactions with the client.

18. The method of claim 17, wherein the interaction concerns a client care issue.

19. The method of claim 18, further comprising using a client profile client care GUI adapted to display information relating to the client care issue.

20. The method of claim 19, wherein the information comprises at least one of a status of the issue, a description of the issue, an assigned owner of the issue, and when the client care issue occurred.

21. The method of claim 1, further comprising generating a work plan for the user.

22. The method of claim 21, wherein the work plan includes any follow-up activities assigned to the user.

23. The method of claim 22, wherein the work plan includes follow-up activities for a time period.

24. The method of claim 23, wherein the time period corresponds to a day, week, or month.

25. The method of claim 22, wherein the work plan is adapted to be filterable by at least one of a time period, a group, a business unit, a status, a contact method, a category, or a user.

26. The method of claim 1, wherein the follow-up activity is generated at least partially in response to an equity.

27. A method comprising:
(a) selecting a campaign type;
(b) selecting criteria for prospects of the campaign;
(c) creating content for the campaign.

28. The method of claim 27, wherein the step of selecting criteria for prospects of the campaign comprises selecting prospects based on service history or purchase history of existing clients.

29. The method of claim 28, further comprising selecting service history or purchase history criteria, wherein the service history or purchase history criteria are selected from the group consisting of lease due, purchase due—purchase, purchase due—recapture, purchase due—lease complete, purchase complete, used—purchase due, used—purchase complete, service only, sales-other, no current vehicle, and combinations thereof.

30. The method of claim 28, wherein the service history or purchase history criteria is entered through a segment selection graphical user interface (“GUI”).

31. The method of claim 27, wherein the step of selecting criteria for prospects of the campaign comprises selecting prospects created by Original Equipment Manufacturers (“OEM”).

32. The method of claim 31 further comprising selecting OEM assigned prospect criteria, wherein the OEM assigned prospect criteria are selected from the group consisting of OEM assigned prospects, OEM disposer customers, and OEM provided customers.

33. The method of claim 32, wherein the OEM assigned prospect criteria is entered through a segment selection GUI.

34. The method of claim 27, wherein the step of selecting criteria for prospects of the campaign comprises selecting prospects based on a client vehicle.

35. The method of claim 34, further comprising selecting client vehicle criteria, wherein the client vehicle criteria are selected from the group consisting of vehicle year, vehicle make, vehicle model, vehicle sale type, vehicle condition, vehicle type, purchase date of the vehicle, service date of the vehicle, vehicle contract termination date, mileage of the vehicle, estimated mileage of the vehicle, VIN of the vehicle, and combinations thereof.

36. The method of claim 34, wherein the client vehicle criteria are entered through a filter selection GUI.

37. The method of claim 27, wherein the step of selecting criteria for prospects of the campaign comprises selecting prospects based on a client criteria.

38. The method of claim 37, further comprising selecting client criteria, wherein the client criteria are selected from the group consisting of client address, the distance of the client's address from the dealership, customer type, e-mail address or e-mail address type, gender, age, current payment, finance rate, and combinations thereof.

39. The method of claim 38, wherein the client criteria are entered through a customer selection GUI.

40. The method of claim 27 further comprising the step of specifying a campaign channel.

41. The method of claim 40, wherein the campaign channels are telephone, e-mail, direct mail, text, social media, or combinations thereof.

42. The method of claim 41 further comprising the step of prioritizing campaign channels.

43. The method of claim 27, wherein the step of specifying campaign type further comprises determining the number of days since a prospect was contacted.

44. The method of claim 43 further comprising selecting prospects based on the number of days since the prospect was last contacted.

45. The method of claim 27 further comprising after the step of creating content for the campaign:
executing the campaign.
